(19) United States
(12) Patent Application Publication
(10) Pub. No.: US 2026/0361561 A1
(43) Pub. Date: Nov. 12, 2026

(54) SENSING SERVICE POLICY DETERMINING METHOD AND APPARATUS, AND COMMUNICATION SYSTEM

(71) Applicant: Huawei Technologies Co., Ltd., Shenzhen (CN)

(72) Inventors: Mingyu Zhao, Shanghai (CN); Xueqiang Yan, Shanghai (CN); Yan Xi, Shanghai (CN); Junfan Wang, Shanghai (CN)

(21) Appl. No.: 19/720,195

(22) Filed: Jun. 25, 2026

Related U.S. Application Data
(63) Continuation of application No. PCT/CN2024/121229, filed on Sep. 25, 2024.

(30) Foreign Application Priority Data
Dec. 27, 2023 (CN) 202311828022.2

(51) Int. Cl. H04L 12/14; H04W 4/02

(52) U.S. Cl. CPC H04L 12/1407; H04W 4/02

(57) ABSTRACT

Embodiments of this application provide a sensing service policy determining method and apparatus, and a communication system. The method includes: A first function network element obtains identification information of a sensing service; and determines policy information of the sensing service based on the identification information of the sensing service. The policy information of the sensing service includes quality of service information of the sensing service. Then, the first function network element sends the policy information of the sensing service to a second function network element.

### CROSS-REFERENCE TO RELATED APPLICATIONS

This application is a continuation of International Application No. PCT/CN2024/121229, filed on Sep. 25, 2024, which claims priority to Chinese Patent Application No. 202311828022.2, filed on Dec. 27, 2023. The disclosures of the aforementioned applications are hereby incorporated by reference in their entireties.

### TECHNICAL FIELD

This application relates to the field of communication technologies, and in particular, to a sensing service policy determining method and apparatus, and a communication system.

### BACKGROUND

In a current communication network, a policy and charging control (PCC) architecture is used to provide users with services and experience in differentiated and intelligent services and implement a dynamic policy management and charging manner. A policy and charging rules function (PCRF) is a core of a PCC architecture of a 4th generation (4G) or long term evolution (LTE) network. The PCRF is used to assist in service data flow detection, policy enforcement, and flow based charging, to ensure reliable monitoring of a service or a use case and a fee related to each use case. A policy control function (PCF) is a core of a PCC architecture of a 5th generation (5G) network. The PCF may be considered as being evolved from the PCRF. The PCF introduces a capability of requesting and monitoring quality of service by session. In addition to retaining such session-based functions, the PCF further introduces another function, including network slice control and a new control mechanism for terminal activities, for example, roaming and mobility management.

In a 4G policy architecture, different end-to-end quality of service (QoS) is loaded through bearers. Data flows on a same bearer can obtain same QoS, and data flows on different types of bearers can obtain different QoS. It can be learned that, a coarse QoS management and control granularity results in problems such as high signaling overheads and a long QoS management and control interaction process. It is difficult to cope with burst services and integrated services. In a 5G policy architecture, an end-to-end quality of service flow QoS flow is used. In addition, two-level mapping of a 5G next-generation user plane function (NG-U) Tunnel and a radio bearer may be performed on an access network side, which allows a radio access network to have a degree of freedom, thereby improving flexibility and adaptability of service bearer management and control to some extent.

With evolution of communication technologies, in addition to providing a connection service, a communication system further provides a sensing service. However, an existing policy architecture cannot support or meet a policy requirement of the sensing service.

### SUMMARY

This application provides a sensing service policy determining method and apparatus, and a communication system. The method may meet or support a policy requirement of a sensing service in a communication network.

According to a first aspect, an embodiment of this application provides a sensing service policy determining method. The method may be performed by a first function network element, or may be performed by a chip, a chip system, a logical module, or software corresponding to the first function network element. This is not limited herein. The first function network element is used as an example. The method may include: The first function network element obtains identification information of a sensing service; and then determines policy information of the sensing service based on the identification information of the sensing service. The policy information of the sensing service includes first quality of service information of the sensing service. The first function network element sends the policy information of the sensing service to a second function network element.

In this embodiment of this application, the first function network element may be deployed standalone in a communication network/communication system, or the first function network element may be co-located with a policy control function network element, or the first function network element may be a policy control function PCF network element. The second function network element may be deployed standalone in a core network, an access network, or a network management system in the communication network/communication system, or the second function network element may be co-located with a first service network element. The first service network element may be but is not limited to a data controller, a sensing service control function, a task anchor, or a task scheduler. Specific deployment, forms, and quantities of first function network elements and second function network elements are not limited in this application.

For example, the sensing service may include identification, speed measurement, ranging, and target positioning.

In the solution of this application, the first function network element may determine the policy information of the sensing service based on the identification information of the sensing service. The policy information of the sensing service includes the first quality of service information of the sensing service. Therefore, it can be learned that the first function network element in this application determines the policy information of the sensing service from a service perspective, and the first function network element can effectively improve quality of service of the sensing service, which is also applicable to an evolved communication system. Therefore, a policy requirement of the sensing service can be met and supported.

In a possible implementation, the policy information of the sensing service further includes one or more of execution range information of the sensing service and collection policy information of the sensing service.

In this embodiment of this application, the collection policy of the sensing service may include but is not limited to a minimum sensing signal used for sensing measurement, a data collection time interval, and real-time or non-real-time data collection.

In a possible implementation, the identification information of the sensing service corresponds to user information of the sensing service (which is equivalent to that the identification information of the sensing service and the user information of the sensing service may be associated with each other), and the user information of the sensing service may include but is not limited to one or more of the following: user subscription information of the sensing service, user registration information of the sensing service, and service subscription information of the sensing service.

For example, the user subscription information or the service subscription information of the sensing service may include a sensing service package, a sensing service monthly package, a gift package offer (for example, an offer quantity and duration), and an incentive manner for participating in the sensing service. The user registration information of the sensing service may include user identity information, address information, user level information, and the like.

In this implementation, the first function network element may effectively determine the corresponding policy information for the sensing service based on the user information of the sensing service.

In a possible implementation, that the first function network element obtains the identification information of the sensing service includes: obtaining the identification information of the sensing service and/or the user information of the sensing service from a service user management network element of the sensing service. The service user management network element of the sensing service may be deployed standalone in a network, or the service user management network element of the sensing service is co-located with a data storage network element, or the service user management network element of the sensing service is a data storage network element.

In this embodiment of this application, the service user management network element of the sensing service may be configured to manage or store the user information of the sensing service, the identification information of the sensing service, and/or the like. For different sensing services, service user management network elements of the sensing services may be a same network element, or may be different network elements. This is not limited. If different sensing services correspond to different service user management network elements, names of the service user management network elements of the sensing services may be the same or may be different. This is not limited either.

In this implementation, the first function network element may effectively obtain the identification information of the sensing service, and further, may effectively obtain the user information of the sensing service.

In a possible implementation, the first quality of service information of the sensing service may include but is not limited to a transmission delay of the sensing service, a maximum bandwidth of the sensing service, a guarantee bandwidth of the sensing service, an execution periodicity of the sensing service, a maximum data burst volume of the sensing service, a quantity of nodes participating in the sensing service, a time difference range of synchronous arrival of the data of the sensing service, a deterministic delay of synchronous arrival of the data of the sensing service, and a priority of the sensing service.

In this implementation, the first function network element allocates information such as a corresponding bandwidth, the corresponding execution periodicity, a corresponding data amount, the corresponding node participating in the sensing service, corresponding transmission delay information of the data of the sensing service, and the corresponding priority of the sensing service to the sensing service based on the user information of the sensing service, to ensure quality of service of the sensing service.

In a possible implementation, the policy information of the sensing service may further include but is not limited to one or more of the following: forwarding policy information of the sensing service and security policy information of the sensing service. In this implementation, the first function network element can further determine other policy information required by the sensing service, to meet various policy requirements of the sensing service. The forwarding policy information of the sensing service may provide a composition policy for implementing a data bearer of the sensing service, and may include topology information such as a source node, a destination node, an intermediate node, and a data pipeline, and policies such as bandwidth and a delay required for data flowing.

According to a second aspect, an embodiment of this application provides a sensing service policy determining method. The method may be performed by a second function network element, or may be performed by a chip, a chip system, a logical module, or software corresponding to the second function network element. This is not limited herein. The second function network element is used as an example. The method may include: The second function network element receives policy information of a sensing service from a first function network element, where the policy information of the sensing service includes first quality of service information of the sensing service; and then, determines, based on the policy information of the sensing service, information about at least one data pipeline corresponding to the sensing service, and determines second quality of service information corresponding to each of the at least one data pipeline.

In this embodiment of this application, the first function network element may be deployed standalone in a communication network/communication system, or the first function network element may be co-located with a policy control function network element, or the first function network element may be a policy control function PCF network element. The second function network element may be deployed standalone in a core network, an access network, or a network management system in the communication network/communication system, or the second function network element may be co-located with a first service network element. The first service network element may be but is not limited to a data controller, a sensing service control function, a task anchor, or a task scheduler. Specific deployment, forms, and quantities of first function network elements and second function network elements are not limited in this application.

For example, types of the sensing service may include identification, speed measurement, ranging, and target positioning.

In the solution of this application, after receiving the policy information of the sensing service, the second function network element further determines, based on the policy information of the sensing service, information about at least one data pipeline used to carry data of the sensing service, and quality of service information corresponding to each data pipeline. In the method, the second function network element may perform more refined global planning and data pipeline orchestration based on the policy information of the sensing service.

In a possible implementation, the first quality of service information of the sensing service may include but is not limited to one or more of the following: a transmission delay of the sensing service, a maximum bandwidth of the sensing service, a guarantee bandwidth of the sensing service, an execution periodicity of the sensing service, a maximum data burst volume of the sensing service, a quantity of nodes participating in the sensing service, a time difference range of synchronous arrival of the data of the sensing service, a deterministic delay of synchronous arrival of the data of the sensing service, and a priority of the sensing service.

In this implementation, the first function network element can provide the transmission delay, bandwidth information, the execution periodicity, data amount information, information about a quantity of participating nodes, a delay difference of data transmission, delay information, and the like that correspond to the sensing service, to guarantee that the second function network element can effectively and accurately plan specific policy information of the sensing service, thereby meeting a policy requirement of the sensing service.

In a possible implementation, the policy information of the sensing service may further include but is not limited to one or more of the following: forwarding policy information of the sensing service and security policy information of the sensing service. In this implementation, the second function network element can further obtain other policy information required by the sensing service, to further determine a more accurate policy for the sensing service, and meet various policy requirements of the sensing service.

In a possible implementation, the policy information of the sensing service further includes collection policy information of the sensing service, and the method may further include: The second function network element determines, based on the collection policy information of the sensing service, collection policy information of a source node corresponding to each of the at least one data pipeline. In this implementation, the second function network element may further determine collection policy information for a source node of each orchestrated data pipeline based on the collection policy information of the sensing service, to implement more refined data collection, thereby ensuring that a collection result is more accurate.

In a possible implementation, the policy information of the sensing service further includes execution range information of the sensing service, and the method further includes: The second function network element obtains status information of a network and/or status information of a node within an execution range of the sensing service based on the execution range information of the sensing service; and that the second function network element determines, based on the policy information of the sensing service, the information about the at least one data pipeline corresponding to the sensing service may include: determining, based on the policy information of the sensing service, and the status information of the network, capability information of the node, and/or the status information of the node, information about a destination node and the information about the source node that correspond to each of the at least one data pipeline.

In this implementation, the second function network element selects, in the execution range of the sensing service based on the status information of the network, status information of each node in the network, and/or capability information (for example, a sensing capability and a computational capability) of the node in the range, a robust and proper node in the execution range, and uses the node to construct the at least one data pipeline used to transmit the data of the sensing service. The second function network element may further determine corresponding quality of service for the at least one data pipeline based on the first quality of service information of the sensing service, and the status information of the network, the capability information of each node in the network, and/or the status information of each node. In this implementation, the second function network element can effectively orchestrate a more accurate layout and higher quality of service for the data bearer of the sensing service.

In a possible implementation, the method further includes: The second function network element sends, based on the information about the source node corresponding to each of the at least one data pipeline, the corresponding second quality of service information and the corresponding collection policy information of the source node to the source node corresponding to the at least one data pipeline.

In this implementation, the second function network element delivers the quality of service information corresponding to each data pipeline and the collection policy information of the source node to the corresponding source node, so that subsequently, each source node effectively implements the collection policy information and reports the data of the sensing service.

In a possible implementation, information about any data pipeline may further include information about at least one intermediate node located within the execution range of the sensing service, and/or identification information of the data pipeline, for example, data pipeline identifier (DPID).

In this implementation, a quantity of nodes arranged on the data pipeline may be flexible, and a location/type, and the like of the node may also be flexible. The second function network element may flexibly topologize and orchestrate each data pipeline. In addition, each data pipeline may be effectively identified based on corresponding identification information.

In a possible implementation, the method further includes: When a first source node of a first data pipeline moves out of the execution range of the sensing service, the second function network element determines a second node in the execution range of the sensing service, and uses the second node as a source node of the first data pipeline, to obtain an updated first data pipeline. The first data pipeline is any one of the at least one data pipeline.

In this implementation, when a source node of any data pipeline changes a location and consequently becomes unavailable, the second function network element may determine a new node for replacement, to ensure transmission efficiency of each data pipeline.

In a possible implementation, the method further includes: The second function network element determines quality of service information corresponding to the updated first data pipeline and collection policy information of the second node; and then, sends the quality of service information corresponding to the updated first data pipeline and the collection policy information of the second node to the second node.

In this embodiment of this application, the updated first data pipeline may continue to use the identification information of the original first data pipeline, or may use new pipeline identification information. This is not limited herein. If the updated first data pipeline uses the new pipeline identification information, each node that stores the identification information of the original first data pipeline may delete the identification information.

In this implementation, when updating the source node of the data pipeline, the second function network element further synchronously updates the quality of service corresponding to the data pipeline and the collection policy information of the source node, to ensure the policy requirement of the sensing service.

The following third aspect describes steps performed by a source node (a first source node of a first data pipeline) of a data pipeline (for example, the first data pipeline) corresponding to a sensing service. For another source node of the first data pipeline or a source node of another data pipeline, refer to the method according to the third aspect. Details of all source nodes are not described in embodiments of this application.

According to a third aspect, an embodiment of this application provides a sensing service policy determining method. The method may be performed by a first source node of a first data pipeline, or may be performed by a chip, a chip system, a logical module, or software corresponding to the first source node of the first data pipeline. This is not limited herein. The first source node of the first data pipeline is used as an example. The method may include: The first source node obtains data of a sensing service based on collection policy information of the first source node; and then, sends the data of the sensing service and indication information of second quality of service information of the first data pipeline.

In this embodiment of this application, the first source node may be a policy enforcement function network element. The policy enforcement function network element may be deployed standalone and serve a second service network element, or the policy enforcement function network element may be deployed in a second service network element. The second service network element may be but is not limited to a terminal, a radio access network node, an access and mobility management function, a session management function, a unified data repository, a user plane function, or a sensing data processing function.

In the foregoing, the collection policy information of the first source node may include but is not limited to one or more of the following:
a minimum sensing signal used for sensing measurement, a data collection time interval or periodicity, and real-time or non-real-time data collection.

Indication information of second quality of service may be identification information (for example, an identifier ID, a sequence number, a label, or a name) of the second quality of service, or indication information of second quality of service is quality of service of the first data pipeline. This is not limited herein.

In the solution of this application, a source node of the first data pipeline collects and obtains the data of the sensing service based on corresponding collection policy information of the source node, to effectively guarantee a collection policy requirement of the sensing service. In addition, the first source node sends the data of the sensing service and the indication information of the second quality of service information of the first data pipeline together. After receiving the data of the sensing service and the indication information of the second quality of service information that are sent by the first source node, a receiving end (for example, a destination node of the first data pipeline) may determine, based on the indication information of the second quality of service information, quality of service information corresponding to the data of the sensing service, to allocate a corresponding resource (for example, a delay, a rate, or a priority) for subsequently processing/transmitting the data of the sensing service, thereby further meeting a policy requirement of the sensing service. In addition, the receiving end may further perform corresponding communication tunnel/radio bearer mapping on the data of the sensing service based on the indication information (for example, a QoS identifier) of the second quality of service, to effectively complete data transmission of the sensing service.

For example, the first source node is a terminal device, the receiving end is an access network device, and the indication information of the second quality of service information corresponding to the first data pipeline is a QoS identifier. After receiving the data of the sensing service and the QoS identifier that are sent by the terminal device, the access network device maps the data of the sensing service from the first data pipeline to a corresponding radio bearer based on the QoS identifier and a quality of service rule.

In a possible implementation, the data of the sensing service and the indication information of the second quality of service information of the first data pipeline are located in a same data packet. In this implementation, the first source node may effectively further send the indication information of the second quality of service information of the first data pipeline when sending the data of the sensing service.

In this embodiment of this application, the data of the sensing service and the indication information of the second quality of service information of the first data pipeline may alternatively be located in a same message, and a type of the message is not limited. In addition, the data of the sensing service and the indication information of the second quality of service information of the first data pipeline may alternatively be located in different data packets or messages. This is not limited either. The first source node may select a proper transmission manner based on an actual requirement.

In a possible implementation, the method further includes: The first source node receives the second quality of service information of the first data pipeline and the collection policy information of the first source node from a second function network element. In this implementation, the second quality of service information of the first data pipeline and the collection policy information of the first source node may be formulated and/or provided by a second function network.

In a possible implementation, when the first source node is deployed in a first radio access network node, that the first source node sends the data of the sensing service and the indication information of the second quality of service information of the first data pipeline includes: mapping the first data pipeline to a corresponding first communication tunnel; and sending the data of the sensing service and the indication information of the second quality of service information of the first data pipeline to a second radio access network node or a core network element through the first communication tunnel. The second radio access network node and the core network element may be destination nodes or intermediate nodes corresponding to the first data pipeline.

In this embodiment of this application, at least one communication tunnel (including the first communication tunnel) may be established in advance, or may be established in real time. This is not limited herein. The first source node may find, through matching, a corresponding communication tunnel based on the quality of service information of the first data pipeline.

For example, a quality of service QoS value or a quality of service QoS range corresponding to each of at least one communication tunnel (including the first communication tunnel) is preset. If a quality of service QoS value of the first data pipeline is a quality of service QoS value corresponding to the first communication tunnel, or a quality of service QoS value of the first data pipeline falls within a quality of service QoS range corresponding to the first communication tunnel, it is determined that a communication tunnel matching the first data pipeline is the first communication tunnel.

In this implementation, when the first source node is an access network node and the destination node is also an access network node or is a core network node, the first source node may perform tunnel mapping, that is, determine the communication tunnel corresponding to the first data pipeline, and further, effectively send the data of the sensing service and the indication information of the second quality of service information of the first data pipeline to the destination node through the communication tunnel.

In a possible implementation, the first communication tunnel may further correspond to a second data pipeline, and the second data pipeline is used to transmit data of another sensing service. It can be learned that, in this embodiment of this application, data pipelines of different sensing services may match different communication tunnels, or may match a same communication tunnel.

In a possible implementation, when the first source node is deployed in a terminal or a terminal device, that the first source node sends the data of the sensing service and the indication information of the second quality of service information of the first data pipeline includes: The first source node maps the first data pipeline to a corresponding first data radio bearer; and sends the data of the sensing service and the indication information of the second quality of service information of the first data pipeline to a radio access network node through the first data radio bearer. The radio access network node may be a destination node or an intermediate node corresponding to the first data pipeline.

In this embodiment of this application, at least one data radio bearer (including the first data radio bearer) may be established in advance, or may be established in real time. This is not limited herein. The first source node may find, through matching, a corresponding data radio bearer based on the quality of service information of the first data pipeline.

For example, a quality of service QoS value or a quality of service QoS range corresponding to each of the at least one data radio bearer (including the first data radio bearer) is preset. If a quality of service QoS value of the first data pipeline is a quality of service QoS value corresponding to the first data radio bearer, or a quality of service QoS value of the first data pipeline falls within a quality of service QoS range corresponding to the first data radio bearer, it is determined that a data radio bearer matching the first data pipeline is the first data radio bearer.

In a possible implementation, the first data radio bearer may further correspond to a second data pipeline, and the second data pipeline is used to transmit data of another sensing service. It can be learned that, in this embodiment of this application, data pipelines of different sensing services may match different data radio bearers, or may match a same data radio bearer.

According to a fourth aspect, an embodiment of this application provides a communication system. The communication system may include a first function network element and a second function network element. The first function network element is configured to: obtain identification information of a sensing service; determine policy information of the sensing service based on the identification information of the sensing service, where the policy information of the sensing service includes first quality of service information of the sensing service; and send the policy information of the sensing service to the second function network element. The second function network element is configured to: determine, based on the policy information of the sensing service, information about at least one data pipeline corresponding to the sensing service, and determine second quality of service information corresponding to each of the at least one data pipeline.

In this embodiment of this application, the first function network element may be deployed standalone in a communication network/communication system, or the first function network element may be co-located with a policy control function network element, or the first function network element may be a policy control function PCF network element. The second function network element may be deployed standalone in a core network, an access network, or a network management system in the communication network/communication system, or the second function network element may be co-located with a first service network element. The first service network element may be but is not limited to a data controller, a sensing service control function, a task anchor, or a task scheduler. Specific deployment, forms, and quantities of first function network elements and second function network elements are not limited in this application.

In a possible design, the first function network element is further configured to perform the method according to any possible implementation of the first aspect, and the second function network element is further configured to perform the method according to any possible implementation of the second aspect.

In a possible design, the communication system may further include at least one destination node and at least one source node that correspond to the at least one data pipeline of the sensing service, and any one of the at least one source node may be configured to perform the method according to any one of the third aspect and the possible implementations of the third aspect.

In this embodiment of this application, the source node, the destination node, and/or an intermediate node each may be a policy enforcement function network element. The policy enforcement function network element may be deployed standalone and serve a second service network element, or the policy enforcement function network element may be deployed in a second service network element. The second service network element may be but is not limited to a terminal, a radio access network node, an access and mobility management function, a session management function, a unified data repository, a user plane function, or a sensing data processing function.

According to a fifth aspect, an embodiment of this application further provides a communication apparatus. The apparatus may be configured to perform the method according to the first aspect. The apparatus may be a first function network element, or the apparatus may be a component (for example, a chip, a chip system, or a circuit) in the first function network element, or the apparatus may be a logical module or software corresponding to the first function network element, or the apparatus may be an apparatus that can be used together with the first function network element.

In a possible implementation, the apparatus may include one-to-one corresponding modules or units for performing the methods/operations/steps/actions described in the first aspect. The module or the unit may be a hardware circuit, may be software, or may be implemented by a hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method according to any one of the first aspect or the possible implementations of the first aspect.

According to a sixth aspect, an embodiment of this application further provides a communication apparatus. The apparatus may be configured to perform the method according to the second aspect. The apparatus may be a first function network element, or the apparatus may be a component (for example, a chip, a chip system, or a circuit) in the second function network element, or the apparatus may be a logical module or software corresponding to the second function network element, or the apparatus may be an apparatus that can be used together with the second function network element.

In a possible implementation, the apparatus may include one-to-one corresponding modules or units for performing the methods/operations/steps/actions described in the second aspect. The module or the unit may be a hardware circuit, may be software, or may be implemented by a hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method according to any one of the second aspect or the possible implementations of the second aspect.

According to a seventh aspect, an embodiment of this application further provides a communication apparatus. The apparatus may be configured to perform the method according to the third aspect. The apparatus may be a first source node, or the apparatus may be a component (for example, a chip, a chip system, or a circuit) in the first source node, or the apparatus may be a logical module or software corresponding to the first source node, or the apparatus may be an apparatus that can be used together with the first source node.

In a possible implementation, the apparatus may include one-to-one corresponding modules or units to perform the methods/operations/steps/actions described in the third aspect. The module or the unit may be a hardware circuit, may be software, or may be implemented by a hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method according to any one of the third aspect or the possible implementations of the third aspect.

In this embodiment of this application, an apparatus of another source node corresponding to the sensing service is similar to that of the first source node. Details are not described again.

According to an eighth aspect, an embodiment of this application provides an apparatus. The apparatus includes at least one processor and a communication interface, the communication interface is configured to communicate with another apparatus, and the processor is configured to run a group of programs, so that the apparatus implements the method according to any one of the first aspect or the possible implementations of the first aspect, or the apparatus implements the method according to any one of the second aspect or the possible implementations of the second aspect, or the apparatus implements the method according to any one of the third aspect or the possible implementations of the third aspect.

According to a ninth aspect, an embodiment of this application further provides a computer-readable storage medium. The storage medium stores a computer program or instructions. When the computer program or the instructions are executed by a computer, the method according to any one of the first aspect or the possible implementations of the first aspect may be implemented, or the method according to any one of the second aspect or the possible implementations of the second aspect is implemented, or the method according to any one of the third aspect or the possible implementations of the third aspect is implemented.

According to a tenth aspect, an embodiment of this application further provides a computer program product including a computer program or instructions. When the computer program product runs on a computer, the method according to any one of the first aspect or the possible implementations of the first aspect is performed, the method according to any one of the second aspect or the possible implementations of the second aspect is performed, or the method according to any one of the third aspect or the possible implementations of the third aspect is performed.

According to an eleventh aspect, an embodiment of this application further provides a chip system. The chip system includes a processor, configured to support a first function network element in implementing the function in the first aspect, or configured to support a second function network element in implementing the function in the second aspect, or configured to support a first source node in implementing the function in the third aspect.

In a possible design, the chip system further includes a memory. The memory is configured to store and load program instructions and data that are executed by an apparatus. The chip system may include a chip, or may include a chip and another discrete component.

It should be noted that, for technical effects that can be achieved in any one of the fourth aspect to the eleventh aspect or the possible implementations of the fourth aspect to the eleventh aspect, correspondingly refer to the descriptions of technical effects that can be achieved in any one of the first aspect to the third aspect or the possible implementations of the first aspect to the third aspect. Details are not described herein again.

### BRIEF DESCRIPTION OF THE DRAWINGS

FIG. 1 is a diagram of a data plane function architecture;

FIG. 2A(1) and FIG. 2A(2) are diagrams of mapping relationships between a data channel and an underlying bearer in 4G and 5G;

FIG. 2B is a diagram of a specific mapping relationship between a data channel and an underlying bearer in a PCC architecture in 5G;

FIG. 3A to FIG. 3D are diagrams of a comparison between a policy architecture provided in embodiments of this application and a current architecture;

FIG. 4 is a diagram of a possible and non-limiting policy architecture applicable to a sensing service according to an embodiment of this application;

FIG. 5 is a diagram of a location of a DFP protocol layer in a 6G data plane protocol stack according to an embodiment of this application;

FIG. 6 is a diagram of a specific mapping relationship among UE1, a RAN1 node, and a PEF according to an embodiment of this application;

FIG. 7 is a schematic flowchart of a sensing service policy determining method according to an embodiment of this application;

FIG. 8A-1 to FIG. 8A-3 are a schematic flowchart of a method in Implementation 1 according to an embodiment of this application;

FIG. 8B is a diagram of a policy architecture of a sensing service according to an embodiment of this application;

FIG. 9 is a diagram of allocation of quality of service information of three data pipelines according to an embodiment of this application;

FIG. 10 is a diagram of updating a source node according to an embodiment of this application;

FIG. 11 is a diagram of a communication apparatus according to an embodiment of this application;

FIG. 12 is a diagram of another communication apparatus according to an embodiment of this application; and

FIG. 13 is a diagram of an apparatus of a chip according to an embodiment of this application.

### BRIEF DESCRIPTION OF THE ILLUSTRATIVE EMBODIMENTS

The following clearly describes the technical solutions in embodiments of this application with reference to the accompanying drawings in embodiments of this application. Terms used in the following embodiments are merely intended to describe specific embodiments, but are not intended to limit this application. As used in the specification and appended claims of this application, singular expressions “one”, “a”, “the”, “the foregoing”, “this”, and “the one” are also intended to include expressions such as “one or more”, unless the contrary is clearly indicated in the context. In embodiments of this application, unless otherwise specified, a quantity of nouns represents “a singular noun or a plural noun”, that is, “one or more”. “At least one” means one or more, and “a plurality of” means two or more. “And/or” describes an association relationship between associated objects and indicates that three relationships may exist. For example, A and/or B may indicate the following three cases: Only A exists, both A and B exist, and only B exists, where A and B may be singular or plural. The character “/” generally indicates an “or” relationship between the associated objects. For example, A/B indicates A or B. “At least one of the following items (pieces)” or a similar expression thereof indicates any combination of the items, including one of the items (pieces) or any combination of a plurality of the items (pieces). For example, at least one item (piece) of a, b, or c indicates a, b, c, a and b, a and c, b and c, or a, b, and c, where a, b, and c may be singular or plural.

Reference to “one embodiment”, “some embodiments”, or the like described in this specification means that one or more embodiments of this application include a specific feature, structure, or characteristic described with reference to embodiments. Therefore, statements “in one embodiment”, “in some embodiments”, “in some other embodiments”, and the like in the differences in this specification do not necessarily mean the same embodiment, but mean “one or more but not all embodiments”, unless otherwise specially emphasized in other ways. The “implementation” in this specification is similar to the foregoing. The terms “include”, “have”, and their variants all mean “include but are not limited to”, unless otherwise specifically emphasized in another manner. The term like “example” or “for example” is used to represent an example, an illustration, or a description. Any embodiment or design scheme described with “example” or “for example” should not be explained as being more preferred or having more advantages than another embodiment or design scheme. Use of the terms such as “example” or “for example” is intended to present a related concept in a specific manner for ease of understanding.

“A plurality of” in embodiments of this application means “greater than or equal to two”. It should be noted that in the descriptions of embodiments of this application, terms such as “first”, “second”, “1”, and “2” (other than a special case of representing a value) are merely used for distinguishing and description, and cannot be understood as an indication or implication of relative importance, or an indication or implication of an order. In addition, the term “indicating” mentioned in descriptions of embodiments of this application may include directly indicating and indirectly indicating. When indication information is described as indicating A, the description may include that the indication information directly indicates A or indirectly indicates A, but does not mean that the indication information necessarily carries A. In addition, steps corresponding to dashed boxes or dashed lines in the drawings for the specification are represented as optional steps.

In embodiments of this application, “data pipeline” and “pipeline” may be replaced with each other. “QoS identifier” and “QoS value” may be replaced with each other, or “QoS value” may be used as an example of “QoS identifier”. This is not limited herein.

This application provides a sensing service policy determining method. To better understand the solutions in embodiments of this application, the following first explains and describes related technical features and names in embodiments of this application. It should be noted that these explanations are intended to make embodiments of this application easier to understand, but should not be considered as a limitation on the protection scope claimed in this application.

### I. Data Plane Function Architecture:

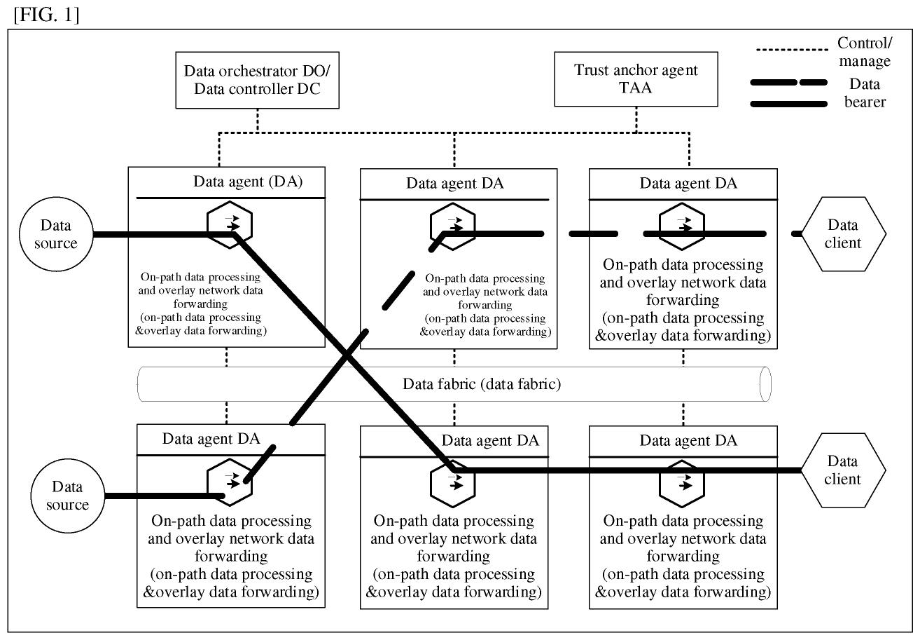

A normalized data service architecture is constructed based on a data plane, and may provide trusted data for intelligent services such as artificial intelligence (AI) and sensing in a communication network. FIG. 1 shows a data plane function architecture. A data plane mainly includes a data orchestrator (DO), a data agent (DA), a trust anchor agent (TAA), and a data storage function (DSF).

The data orchestrator DO is responsible for a coarse-grained and non-real-time data orchestration task. The DO may be configured to: select a DA based on a received data service request, and orchestrate and manage a DA function, to dynamically establish an end-to-end (end-to-end, E2E) logical data transmission network topology for a data application, orchestrate data flowing between DAs in such a network, and feed back, to the application, a response to the request.

The DO may further convert the received data service request into a corresponding data pipeline construction request, and send the data pipeline construction request to a data controller DC. The DO may further be responsible for collaboration with another network service. For example, a computational power network service orchestrates computational power, and the DO orchestrates data. In some embodiments, the DO and the DC may alternatively be deployed in a same entity device.

In addition, the DO has a built-in data security protection and privacy protection technology library that includes differential privacy, homomorphic encryption, and zero-knowledge proof and that is used to provide a data security and privacy protection capability and enable a data protection technology to the DA based on a requirement.

The data controller (DC) is responsible for a fine-grained real-time orchestration task. The DC may be configured to: monitor and manage the DA in real time, and combine data pipelines based on a capability of the DA and a data service requirement. The DO and DC may cooperate to implement data pipeline elasticity (the data pipeline elasticity refers to fast adaptation to changing requirements) and programmability (namely, flexible configuration of data pipelines).

The data agent DA is configured to provide functions such as data collection, preprocessing, storage, and analysis. The DA may be deployed on a network function (NF), a radio access network (RAN), a transfer network (TN) node, a terminal, an operation, administration, and maintenance (operation, administration, and maintenance, OAM) system of an operator network, or the like, or may be deployed in a standalone (standalone) manner.

In this embodiment of this application, the DO/DC may select a data agent DA based on a service requirement and capabilities reported by all DAs, and orchestrate the DA to establish a dynamic data bearer, to provide a service for a service. One data bearer has one service identifier (ID) and one data service task identifier (data service task ID, DSID). One data bearer may include a plurality of data pipelines (data pipeline). Each data pipeline has a respective ID, for example, a data pipeline identifier (data pipeline ID, DPID). Each data pipeline includes a series of data processing units in sequence based on a requirement. An output of a previous unit is an input of a current unit. Therefore, in terms of data collection, preprocessing, storage, and application/analysis, a data flow carried on the data bearer may be output from the DA based on service requirements and provided by the DA for an external application through a service interface.

Data storage function DSF: The DSF is an extension of storage of the DA, supports storage of streaming (streaming) data and batch (batch) data, and supports distributed or centralized deployment.

The trust anchor agent TAA is configured to provide a trust service such as authentication authorization accounting (AAA), and may store data that cannot be tampered with, for example, a public key of a terminal or a network device, a short transaction, an index, or important data that cannot be tampered with. The data service architecture uses the trust anchor agent to enable users to have independent control over data, implement data trustworthiness, auditability, and traceability, and meet compliance requirements of the personal information protection law (PIPL) or the general data protection regulation (GDPR).

### II. Policy and Charging Control (PCC) Architecture:

The PCC architecture is a common policy architecture in a current mobile communication network. A PCRF is a core of a PCC architecture of a 4G or LTE network. The PCRF is used to assist in service data flow detection, policy enforcement, and flow based charging, to ensure reliable monitoring of a service or a use case and a fee related to each use case. A PCF is a core of a PCC architecture of a 5G network. The PCF is evolved from the 4G policy and charging rules function (PCRF). Functions of the PCF introduce a capability of requesting and monitoring quality of service by session. In addition to retaining the session-based function, the PCF further introduces an additional function, including network slice control and a new control mechanism for terminal activities, for example, roaming and mobility management.

Differences between the 4G policy architecture and the 5G policy architecture are mainly as follows:
(1) Mapping relationships between a data channel and an underlying bearer are different: There is an end-to-end (end-to-end, E2E) bearer in 4G, for example, an evolved packet system (EPS) bearer. End-to-end quality of service QoS is achieved through an EPS bearer. 5G end-to-end E2E transmission is performed through a QoS flow, and the transmission relates to two-level mapping, for example, mapping of a next-generation user plane function tunnel (NG-U Tunnel) and mapping of a radio bearer (RB) in 5G.

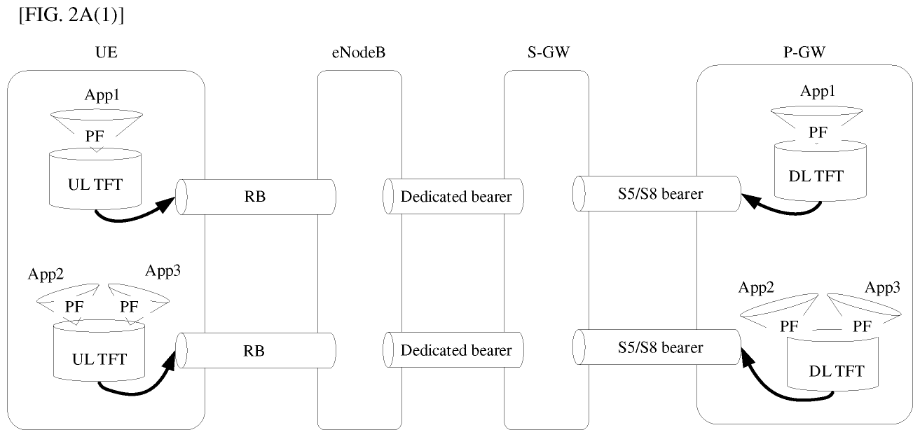

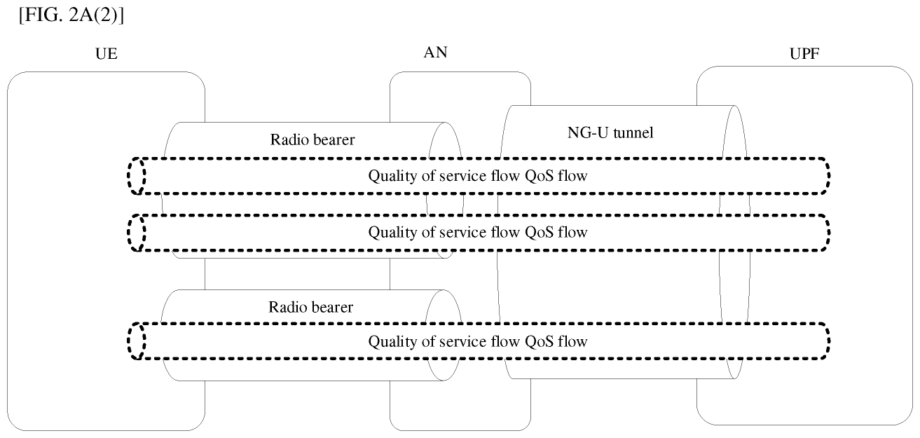

One-level mapping in 4G: There is a one-to-one correspondence between underlying bearers in 4G. A transmitting end completes mapping of a data packet to an evolved packet system EPS bearer, that is, may implement association between the data packet and the bearer. As shown in FIG. 2A(1), for mapping of an uplink EPS bearer, between user equipment UE and a base station eNodeB, a physical transmission channel of the EPS bearer is a radio bearer RB, and the UE may map data of one uplink service (for example, app1) to one RB through an uplink (UL) traffic flow template (TFT) (the TFT is a set of packet filters (PFs)), to send the data to the base station eNodeB, or the UE may aggregate data of a plurality of uplink services (for example, app2 and app3), and map the aggregated data to one RB through a UL TFT (a set of a plurality of groups of PFs), to send the aggregated data to the base station eNodeB; between the eNodeB and a serving gateway (serving gateway, S-GW), a physical transmission channel of the EPS bearer may be a dedicated bearer (one type of S1 bearer), and the eNodeB may map the RB to the dedicated bearer in a one-to-one manner, to transmit the RB to the S-GW through the dedicated bearer; and between the S-GW and a packet gateway (PDN gateway, P-GW), a physical transmission channel of the EPS bearer is an S5/S8 bearer (GTP tunnel), and the S-GW may map the dedicated bearer to the S5/S8 bearer in a one-to-one manner, to transmit the dedicated bearer to the P-GW through the S5/S8 bearer. For mapping of a downlink EPS bearer, the P-GW side may map data of one service (for example, app1) to one S5/S8 bearer through a downlink (DL) traffic flow template TFT, or may aggregate data of a plurality of services (such as app2 and app3), and map the aggregated data to one S5/S8 bearer through a DL TFT, to send the aggregated data to the S-GW; the S-GW side maps the S5/S8 bearer to a dedicated bearer in a one-to-one manner, to send the S5/S8 bearer to the eNodeB; and the eNodeB maps the dedicated bearer to an RB in a one-to-one manner, to send the RB to a terminal.

Two-level mapping in 5G: A data packet transmitting end performs mapping of a data packet to a quality of service flow (QoS flow), and mapping of the quality of service flow (QoS flow) to a radio bearer (radio bearer) on an air interface side, to implement end-to-end association between the data packet and the QoS flow. Both a mapping relationship between a data packet and a quality of service flow (QoS Flow) and a mapping relationship between a quality of service flow (QoS flow) and a radio bearer (radio bearer) are N:1, where N is an integer greater than or equal to 1. As shown in FIG. 2A(2), there is a mapping between a quality of service flow (QoS flow) and a radio bearer (radio bearer) between UE and an access network (AN), and there is a mapping between a radio bearer (Radio Bearer) and a next-generation user plane function tunnel (NG-U tunnel) between an access network AN and a user plane function (UPF) in a core network. A mapping relationship between a radio bearer (radio bearer) and a next-generation user plane function tunnel (NG-U Tunnel) is M:1, where M is an integer greater than or equal to 1.

FIG. 2B shows a specific policy mapping relationship in 5G. As shown in FIG. 2B, one-level mapping is mapping of a data packet to a quality of service flow (QoS flow), and two-level mapping is mapping of a quality of service flow (QoS flow) to a data radio bearer (DRB) on a radio air interface side. Both a correspondence between a quality of service rule QoS rule and a QoS flow on the UE and a correspondence between a packet description rule (PDR) and a QoS flow on the user plane function UPF are a correspondence of N:1 (N is an integer greater than or equal to 1). A quality of service flow identifier (QoS flow ID, QFI) may be added at service data adaptation protocol (SDAP) layers of user plane protocol stacks of the UE and the gNB. In this way, a receiving end may perform mapping between a QoS flow and a DRB by reading a value of the identifier.
(2) 4G and 5G service traffic steering mechanisms are different. One PDU session (PDU session) has only one N3/N9 interface. The N3/N9 interface uses a general packet radio service (GPRS) tunneling protocol (GPRS tunneling protocol, GTP), and corresponds to only one tunnel endpoint identifier (TEID). To identify different QFIs, a new field is required. A QFI parameter is encapsulated in a packet header of a GTP tunnel of a user plane packet of the N3 interface. padding in a signaling file includes four bits. First two bits are used to identify an uplink or downlink, and last two bits are used to identify the QFI.

In the 4G policy architecture, all data flows on a same bearer obtain a same QoS guarantee (for example, a scheduling policy, buffer queue management, and link layer configuration), and different QoS guarantees use different types of EPS bearers. A 4G QoS architecture has problems such as coarse-grained QoS management and control, high signaling overheads, and a long QoS management and control interaction process. Therefore, the 4G QoS architecture is not applicable to burst services and integrated services.

In the 5G policy architecture, a basic granularity of a 5G QoS architecture is refined to a QoS flow. Compared with 4G QoS management and control, two-level mapping of the 5G QoS architecture allows a RAN side to have a degree of freedom. The 5G QoS system architecture improves flexibility and adaptability of service bearer management and control to some extent.

With evolution of communication technologies, in addition to providing a connection service, a communication system further provides a sensing service. However, an existing policy architecture cannot meet or support a policy requirement of the sensing service. For example, there may be the following reasons:
(1) For the sensing service, a source node and a destination node are selected more flexibly, instead of being anchored on UE, a UPF, or the like, and may be terminated on a RAN node, which brings a challenge to sensing service classification and policy enforcement. An existing policy architecture does not support the sensing service the sensing service.
(2) A current policy architecture is unaware of a service, and is from a terminal perspective. An uplink/downlink source adds a QoS label based on information such as a 5-tuple, and performs traffic steering. However, a global policy orchestration mechanism is lacked for multi-terminal or multi-source sensing services.
(3) The current policy architecture lacks real-time sensing and policy updating capabilities, especially on a radio access network RAN side. In a 5G network, a QoS requirement is determined by a core network. The core network cannot obtain real-time information such as a resource status and an air interface change on the access network side in a timely manner, and the core network formulates a QoS policy and a parameter based only on user subscription information and a service requirement. Consequently, a QoS requirement of a service cannot match a QoS capability of a network, causing problems such as poor service experience and low network running efficiency.

In view of the foregoing problem, embodiments of this application provide a policy architecture and a technical solution, to support or meet a policy requirement of a sensing service. The policy architecture and the technical solution provided in embodiments of this application may be applied to various communication systems evolved after 5G, for example, a 6G communication system. Similarly, the policy architecture and the technical solution provided in embodiments of this application may also be applied to a 4G communication system, for example, a long term evolution LTE communication system, and may also be applied to a 5G communication system, for example, a 5G new radio (NR) communication system. This is not limited herein. In addition, the policy architecture and the technical solution provided in embodiments of this application may be further applied to a satellite communication system. The satellite communication system may be integrated with the foregoing communication system. The policy architecture and the technical solution provided in embodiments of this application may also be applied to another communication system, provided that the communication system has a policy formulation requirement. In addition, the communication system may be applied to a future-oriented communication technology. The system described in embodiments of this application is intended to describe the policy architecture and the technical solution in embodiments of this application more clearly, and constitutes no limitation on the policy architecture and the technical solution provided in embodiments of this application. A person of ordinary skill in the art may learn that with evolution of a policy architecture, the policy architecture and the technical solution provided in embodiments of this application are also applicable to similar technical problems.

The following describes the policy architecture provided in embodiments of this application.

In the policy architecture provided in embodiments of this application, in addition to an existing connection policy, policy services for services such as security, data, and sustainability are further added. These policy services may be referred to as beyond-connectivity policy services, or may be referred to as another name. This is not limited herein.

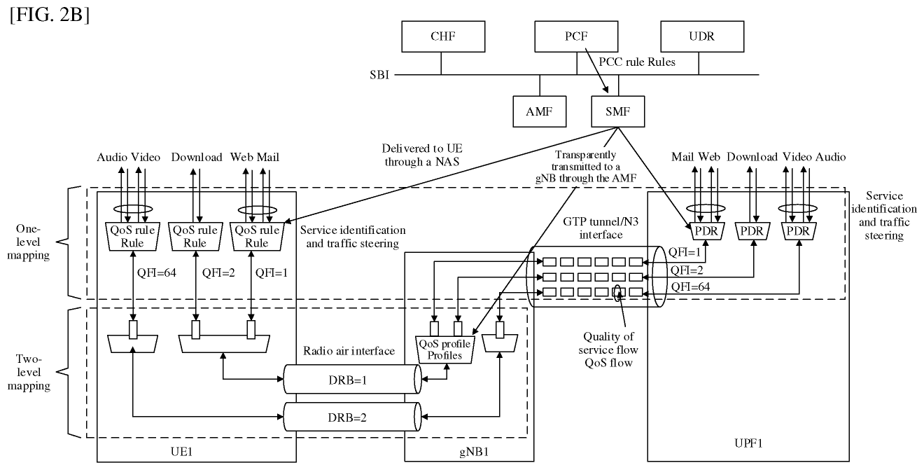

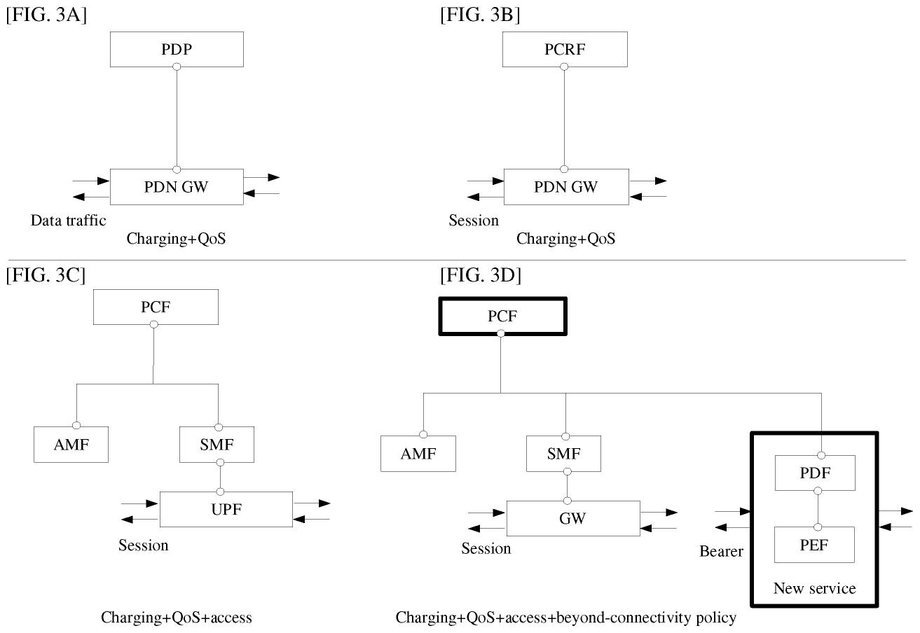

FIG. 3A to FIG. 3D shows a policy architecture provided in an embodiment of this application and several existing policy architectures. FIG. 3A shows a 3G policy architecture, and FIG. 3B shows a 4G policy architecture. It can be learned that the 3G policy architecture and the 4G policy architecture improve quality of service QoS management and charging. FIG. 3C shows a 5G policy architecture. It can be learned that access management (AM) and UE access policy management are added in the 5G policy architecture. In conclusion, 3G to 5G policy architectures are mainly connectivity-oriented policy architectures, namely, a policy of establishing a communication channel between UE and a network anchor (for example, a 4G public data network (PDN) gateway (GW), or a 5G UPF).

FIG. 3D shows a policy architecture that supports a beyond-connectivity policy service according to an embodiment of this application. As shown in FIG. 3D, in the policy architecture, a beyond-connectivity policy architecture is newly added based on the connectivity-oriented policy architecture. The beyond-connectivity policy architecture mainly includes functions such as a policy control function (PCF), a policy delivery function (PDF), and a policy enforcement function (PEF). A policy architecture that originally includes the PCF, the session management function (SMF)/access and mobility management function (AMF), and a user plane function (UPF) may still be used to serve a connection policy.

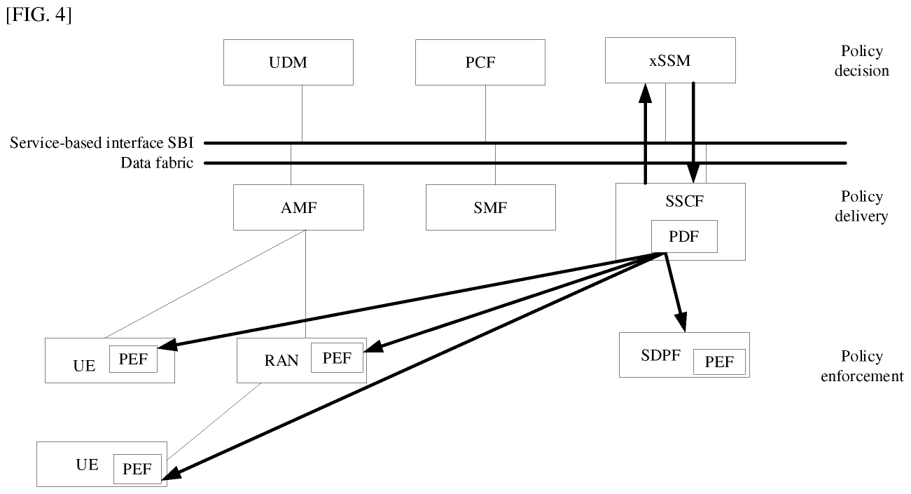

FIG. 4 is a diagram of a possible and non-limiting policy architecture (which may be briefly referred to as a sensing policy architecture below) applicable to a sensing service according to an embodiment of this application. As shown in FIG. 4, the policy architecture includes unified data management (UDM), a policy control function PCF, an access and mobility management function AMF, a session management function SMF, a sensing service control function (SSCF), user equipment (UE), a (radio) access network (radio access network, (R)AN), and a sensing data processing function (SDPF).

In addition, in the policy architecture, a function/network element (equivalent to a function/network element of the foregoing beyond-connectivity policy service) for providing a sensing service policy service is added, including: a sensing service policy decision function, a sensing service policy delivery function (PDF in FIG. 4), a sensing service policy enforcement function (PEF in FIG. 4), and a sensing service management function (for example, service subscriber management (x service subscriber management, xSSM) in FIG. 4).

The sensing service policy decision function may obtain user subscription information of the sensing service (beyond-connectivity service), and the like from the sensing service management function, formulate a policy of the sensing service based on the user subscription information, and the like of the sensing service, and then send the policy of the sensing service to the sensing service policy delivery function. The sensing service policy delivery function may generate a policy parameter of a specific sensing service perspective based on the policy of the sensing service and information such as an actual requirement of the sensing service and a network status, and then send the policy parameter of the specific sensing service perspective to the sensing service policy enforcement function for enforcement.

In the foregoing, the sensing service policy decision function may be integrated or built in the policy control function PCF in FIG. 4, or may be an independent NF or network element. This is not limited herein. If the sensing service policy decision function is integrated or built in the policy control function PCF, it is equivalent to that a policy decision function for a sensing service is added to the PCF based on an existing function.

The following describes in detail network elements/functions/apparatuses in the policy architecture shown in FIG. 4.

Functions of UDM include: managing a user subscription context, being responsible for managing subscription data of a user/terminal, and being responsible for notifying a corresponding network element when the subscription data is modified.

Functions of the AMF include: access management and mobility management of a terminal, and being responsible for terminal status maintenance, terminal reachability management, mobility management (MM), non-access stratum (NAS) message forwarding, session management (SM), N2 message forwarding, and the like.

Functions of the SMF include: allocating a resource to a session of a terminal and releasing a resource. The resource includes session quality of service (QoS), a session path, a forwarding rule, or the like. The SMF is responsible for selecting or reselecting a UPF, and allocating an internet protocol (IP) address, and is further responsible for establishing, modifying, and releasing a bearer, and the like.

User equipment UE: The user equipment may be a terminal device. The terminal device may communicate with a core network via an access network AN. The terminal device may include an access terminal, a subscriber unit, a subscriber station, a mobile station, a remote station, a remote terminal, a mobile device, a user terminal, a terminal, a wireless communication device, a user agent, or a user apparatus. The access terminal may be a cellular phone, a cordless phone, a session initiation protocol (SIP) phone, a wireless local loop (WLL) station, a personal digital assistant (PDA), a handheld device with a wireless communication function, a compute device, another processing device connected to a wireless modem, a vehicle-mounted device, a wearable device, a terminal in various communication networks (for example, a 6G communication network) that evolve after 5G, or the like.

Functions of the (R)AN include: being mainly responsible for providing a wireless connection for the terminal device, ensuring reliable transmission of uplink and downlink data of the terminal device, and the like.

In a possible scenario, an access network device may be a base station (base station), an evolved NodeB (eNodeB), a transmission and reception point (transmission and reception, TRP), a transmission point (TP), a next-generation NodeB (gNB), a next-generation NodeB in a 6th generation (6th generation, 6G) mobile communication system, a base station in a future mobile communication system, a satellite, an access point (AP) in a Wi-Fi system, an integrated access and backhaul (IAB) node, or a network device in a non-terrestrial network (NTN) communication system of a mobile switching center, and may be deployed on a high-altitude platform, a satellite, or the like. The access network device may be a macro base station, a micro base station, or an indoor station, a relay node or a donor node, or a radio controller in a cloud radio access network (CRAN) scenario. Alternatively, the access network device may be a device that functions as a base station in device to device (D2D) communication, internet of vehicles communication, uncrewed aerial vehicle communication, or machine to machine communication. In an embodiment, the access network device may alternatively be a server, a wearable device, a vehicle, a vehicle-mounted device, or the like. For example, an access network device in a vehicle to everything (V2X) technology may be a road side unit (RSU).

In another possible scenario, a plurality of access network devices cooperate to assist the terminal in implementing radio access, and different access network devices each implement a part of functions of a base station. For example, the access network device may be a central unit (CU), a distributed unit (DU), a CU-control plane (CP), a CU-user plane (UP), or a radio unit (RU). The CU and the DU may be separately arranged, or may be included in a same network element, for example, a baseband unit (BBU). The RU may be included in a radio frequency device or a radio frequency unit, for example, included in a remote radio unit (RRU), an active antenna processing unit (active antenna unit, AAU), or a remote radio head (RRH). It may be understood that the access network device may be a CU node, a DU node, or a device including a CU node and a DU node. In addition, the CU may be classified as a device in a radio access network RAN, or the CU may be classified as a device in a core network (CN). This is not limited herein.

In different systems, the CU (or the CU-CP and the CU-UP), the DU, or the RU may also have different names, but a person skilled in the art may understand meanings thereof. For example, in an open radio access network (open RAN, ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

Functions of xSSM include functions such as storage/management of user subscription information of a sensing service, a registration request of a new user, and service subscription.

Herein, x may be used to represent a service, and x may be a name, a code, or the like of the service. For example, x is Sensing, and xSSM represents sensing service subscriber management (sensing SSM, SSSM).

In this embodiment of this application, xSSM may be co-located with the unified data management function UDM, or xSSM may be co-located with another storage/management network element, or xSSM may be deployed standalone. This is not limited herein.

Functions of the SSCF include: receiving capability registration of a sensing entity, and controlling and orchestrating a sensing service. The SSCF may communicate with another network function NF through a service based interface (SBI). In a possible implementation, when a sensing data service architecture is constructed based on the data plane function architecture shown in FIG. 1, to provide a data service for the sensing service, the SSCF may be equivalent to the DO/DC in the data plane function architecture. In this embodiment of this application, a PDF may be deployed or integrated in the SSCF.

Functions of the PDF include: generating a policy parameter corresponding to a specific sensing service perspective (for example, data pipelines) based on a policy of the sensing service from the PCF and information such as an actual requirement of a sensing service and a network status, and sending the policy parameter to the PEF for enforcement.

For example, the functions of the PDF may include: 1. If the PDF is disposed in a DO/DC, the DO/DC chooses to establish a data bearer for a sensing service based on a policy of the sensing service of the PCF, and determines a source node and a destination node, and the PDF separately delivers an establishment policy of a to-be-established pipeline with a DPID to (uplink and downlink) PEFs of the source node and the destination node. 2. A data transmission policy, a collection policy, a charge mode, an access policy when a user is in arrears, an incentive policy, and the like are generated (a policy of a service perspective is determined by the PCF, and the PDF determines management and a policy specific to each data pipeline DP and delivers the management and the policy to the PEF for enforcement). 3. The PDF determines a quality of service value of the sensing service, and delivers the quality of service value to the PEFs of the source node and the destination node that correspond to a data bearer of the sensing service.

In this embodiment of this application, the PDF may be deployed standalone, or may be deployed inside any one of a data controller (DC), a sensing service control function SSCF, a task anchor/task scheduler (task anchor/task scheduler, TA/TS), or the like, or may be co-located in a same apparatus with any one of a data controller (DC), a sensing service control function (SSCF), a task anchor/task scheduler (TA/TS), or the like. This is not limited.

In the foregoing, as a function in a data plane architecture, the DC (or DO) may be configured to: collect a capability reported by an underlying data agent (DA), select a proper DA based on a service requirement and the capability reported by the DA, and orchestrate a data bearer, including a topology structure, a function of each node, and the like, to complete the service. In a possible implementation, the DC may be deployed in the access network (which may be referred to as a data controller RAN-DC of a radio access network), or may be deployed in the core network (which may be referred to as a data controller CN-DC of the core network). This is not limited herein.

The TA/TS is a core function in a task architecture. The task architecture uses a task as a central mechanism. The task can be defined and can be completed through cooperation by using four elements: computational power, an algorithm, data, and a connection. The TA/TS is configured to: decompose the task into one or more subtasks, and orchestrate and schedule resources of the four elements to complete the task.

For example, after receiving a sensing service decision rule from the PCF, the PDF directly generates a specific policy parameter of a sensing service perspective based on the sensing service decision rule of the PCF, or the PDF generates a specific policy parameter of a sensing service perspective based on a sensing service decision rule of the PCF and orchestration and control requirements of the DC, the SSCF, the TA/TS, and the like, and then delivers the specific parameter to the PEF. In addition, the PDF may directly deliver the specific parameter to an independent PEF, or transparently transmit the specific parameter to a built-in PEF through a network element. For example, the PDF transparently transmits the specific parameter to a built-in PEF of the UPF through the SMF, the PDF transparently transmits the specific parameter to a built-in PEF of the RAN through the AMF, and the PDF transparently transmit the specific parameter to a built-in PEF such as the UE through a non-access stratum NAS message. This is not limited. The PDF may be a RAN-DC or a CN-DC. In this way, the PDF may sense a resource change based on real-time information reported by the DA, and perform real-time policy updating, thereby implementing integration of a communication network and a sensing service and dynamic self-adaptation, and QoS supports cross-layer and cross-domain connection.

Functions of the SDPF include: being used to implement a data plane function of the sensing service. For example, the SDPF is used to process sensing data of the sensing service, so as to obtain a sensing result of the sensing service. In a possible implementation, the PEF may be deployed or integrated in the SDPF.

Functions of the PEF include: The PEF receives a policy parameter delivered by the PDF, collects and processes sensing service data, and the like.

In this embodiment of this application, the PEF may be deployed standalone, or may be built or integrated in the UE, the RAN node, the UPF, the SDPF, or the like. This is not limited herein.

In a possible implementation, when a sensing data service architecture is constructed based on the data plane function architecture shown in FIG. 1, to provide a data service for the sensing service, the SDPF may be equivalent to the DA in the data plane function architecture.

The PEF is executed from a service perspective. One sensing service is provided with a bearer service by one data bearer, and an identifier corresponding to the data bearer may be a data service task identifier (DSID). One data bearer may include one or more data pipelines, and each data pipeline is correspondingly identified by using one DPID. A minimum granularity of PEF policy enforcement is a data pipeline (in other words, a data pipeline is a basic unit of PEF policy enforcement).

Data pipelines (with a same DPID) that have a same quality of service QoS requirement and belong to a same sensing service between the source node and the destination node are a minimum granularity of quality of service QoS processing in a communication system in this embodiment of this application. Quality of service QoS of the data pipeline may be controlled by the PDF, or may be preconfigured, or may be determined or established in a data pipeline IP address (DPIP) establishment process or a data pipeline IP address (DPIP) modification process. This is not limited herein.

In this embodiment of this application, there is terrestrial side mapping and air interface bearer mapping on the PEF side, which are as follows:
1. Terrestrial side mapping: mapping from a data pipeline (data pipeline) to a tunnel (tunnel) (two ends on a terrestrial side) 2. Air interface bearer mapping: mapping from a data pipeline (data pipeline) to a data radio bearer DRB (namely, mapping between two ends of an air interface).

In this embodiment of this application, when a tunnel is established, a source end may add a QoS identifier/label to a corresponding protocol layer of data based on a transmission protocol. In addition, there may be a plurality of DRBs from a terminal to an air interface, and a correspondence between a DRB and a service (or a data pipeline) may be 1:N.

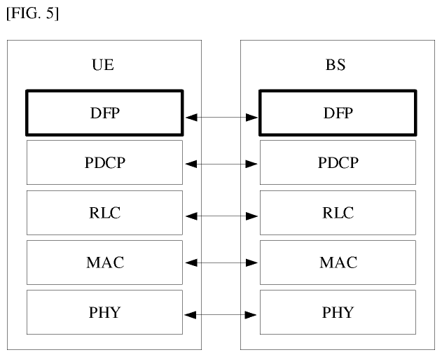

FIG. 5 shows a location of a data forwarding protocol (DFP) layer in a data plane protocol stack. As shown in FIG. 5, the data plane protocol stack may include a data forwarding protocol DFP layer, a packet data convergence protocol (PDCP) layer, a radio link control (RLC) layer, a medium access control (MAC) layer, and a physical (PHY) layer. The DFP layer includes the following two functions:

Function 1: A DFP layer of a transmitting end (or a source end) may add a QoS identifier/label corresponding to a data pipeline, and the like to an uplink data packet or a downlink data packet, for example, a QoS ID. Correspondingly, a DFP layer of a receiving end (or a destination end) may read the QoS identifier/label from the uplink data packet or the downlink data packet. Function 2: One or more data pipelines (data pipelines) are mapped to one data radio bearer (DRB).

For example, for the downlink data packet, if a source end PEF sends the downlink data packet to a destination end UE, or a source end RAN1 node sends the downlink data packet to a destination end RAN2 node, or a source end NF1 node sends the downlink data packet to a destination end NF2 node, a DFP layer of the source end PEF, RAN1 node, or NF1 adds the QoS identifier/label to the downlink data packet, and sends the downlink data packet carrying the QoS identifier/label.

In addition, if an intermediate end at which the downlink data packet carrying the QoS identifier/label arrives is a RAN node, two-level mapping (namely, terrestrial side mapping and air interface bearer mapping) is performed on a RAN side.

For the uplink data packet, if a source end UE sends the uplink data packet to a destination end PEF, the UE adds the QoS identifier/label to the uplink data packet (or a packet header of the uplink data packet). If a source end RAN node sends the uplink data packet to a PEF, the RAN node adds the QoS identifier/label to the uplink data packet (or a packet header of the uplink data packet).

In addition, if an intermediate end at which the uplink data packet carrying the QoS identifier/label arrives is a RAN node, two-level mapping (namely, terrestrial side mapping and air interface bearer mapping) is performed on a RAN side.

In this embodiment of this application, the data radio bearer may also be referred to as a data air interface bearer or another name. This is not limited herein. The terrestrial side mapping and the air interface bearer mapping may alternatively be named with other names. For example, the air interface bearer mapping may be referred to as air interface mapping. This is not limited. A corresponding replacement may be performed based on an application scenario, provided that consistent essential content is expressed.

Functions of the PCF include: being used to provide user policy management, generate and manage a user, a session, and a QoS flow processing policy, and make a policy decision for the sensing service.

The PCF not only has policy decision functions for connection, charging, and access (for example, AM access management and UE access policy management), but also introduces policy decision functions for data (for example, sensing type data).

For example, as shown in Table 1, content of each policy separately corresponds to an input source of the policy and an output of the policy. For the content of each policy, the PCF may obtain input information of the policy from the corresponding input source, perform policy computing based on the input information of the policy, and determine the corresponding output of the policy.

For connection policies (for example, connection+charging+access policies), the PCF may obtain user subscription information from UDM, calculates an internet access quality guarantee for a user, and matches a “rule”. The “rule” carries a QoS parameter of a user access service determined by the PCF. The PCF may also dynamically adjust a policy parameter based on a real-time analysis result of a network data analytics function (NWDAF) for a network status, and send the policy parameter to an SMF/AMF, a UPF, or UE.

For a beyond-connectivity policy (namely, a policy other than the connection, charging, and access policies, for example, the policy of the sensing service), the PCF may obtain user subscription information of a sensing service from xSSM (or SSSM), calculate a quality of service index for the sensing service, and sends the quality of service index to a PDF. Then, the PDF generates a policy parameter of a specific sensing service perspective based on an actual requirement of the sensing service, and sends the policy parameter to each PEF.

For example, the PDF delivers the policy parameter of the sensing service perspective together with a match and action (match and action, M&A) mechanism. The PCF may also dynamically adjust the policy parameter from the sensing service perspective based on a real-time analysis result of an NWDAF for a network status, and send the policy parameter to each PEF. In this application, the M&A mechanism means that at least one collection/filtering condition and an action corresponding to each collection/filtering condition are set in a data orchestrator DO or a data controller DC, M&A is sent to a data processing node, and a corresponding action is performed when a data packet matches a collection/filtering condition.

In this embodiment of this application, for the sensing service, after the PCF receives a request input of a requester of the sensing service, the PCF determines an execution range area, a collection policy, quality of service, and the like of the sensing service. In a possible implementation, for an input source and an output source of a policy of the sensing service, refer to Table 1. The PCF may obtain input information of the policy corresponding to sensing from the input source (for example, xSSM) of the policy corresponding to sensing, perform policy computing based on input information of the policy, and determine an output of the policy corresponding to sensing. A data bearer established for the sensing service includes topology composition such as a source node, an intermediate node, a destination node, and a data pipeline, and functions that can be implemented by each node, such as analysis and storage functions. These functions are determined by the DC/SSCF (built or integrated with the PDF) and belong to the scope of service processing. Therefore, the PCF specifies only an area range of a source, a collection policy (or a collection setting) of the source, and quality of service of the service perspective (or a transmission setting of the service perspective). In addition, destination information of sensing data is used as content of a data pipeline transmission (service perspective) range.

After the sensing service is processed, a sensing result is fed back to a requester of the sensing service. If the requester is a terminal, a location, for example, the SDPF, calculated based on the final sensing result needs to be considered from a perspective of an existing connection, a connection is established, a connection policy is determined, and the final sensing result is sent to the terminal. If the requester is a third party, the sensing result may be sent to the third party through a network exposure function (NEF), which may be implemented based on a current connection policy herein. Details are not described herein again.

Table 1 is merely presented as an example of a part of policy content for description. Actually, the policy architecture provided in this embodiment of this application may further include more or less policy content. Details are not described herein again.

FIG. 4 is merely an example of the sensing policy architecture provided in this embodiment of this application. Compared with the sensing policy architecture shown in FIG. 4, the sensing policy architecture provided in this embodiment of this application may actually further include more or fewer function network elements. This is not limited. The sensing policy architecture provided in this embodiment of this application may be further applied to another communication network/system/scenario. If the sensing policy architecture is applied to another communication network/system/scenario, all or a part of function network elements shown in FIG. 4 may be correspondingly replaced. In addition, the function network element in the sensing policy architecture in this embodiment of this application may also be represented by using another name. This is not limited herein.

TABLE 1

| | | Output of the policy |
|---|---|---|
| | Input source of a policy | (also referred to as an |
| | (also referred to as an input | output of policy |
| Policy content | source of policy computing) | computing) |
| Connection + charging + | The input source of the | Internet access |
| access (AM and UE) | policy is UDM (traffic package, | quality guarantee for a |
| | monthly traffic package, gift | user, and a matched |
| | package offer, and the like). | “rule”: The “rule” carries a |
| | Input information of the | quality of service QoS |
| | policy may include at least one | parameter that is of a user |
| | of the following: | access service determined |
| | a location area (for | by a PCF, and may include |
| | example, a hotspot, a central | at least one of the |
| | business district, or an office | following: |
| | area) of a user; | a session |
| | a terminal type (for | management SM policy: a |
| | example, a mobile phone, a | session aggregate |
| | tablet computer, or a | maximum bit rate |
| | computer); | (Session-AMBR), a 5QI, |
| | a user level (for example, a | an address resolution |
| | very important person (VIP) | protocol (ARP), or the |
| | and common); | like; |
| | a service type (for example, | an access |
| | Internet browsing, video, email, | management AM policy: |
| | and voice); | service area restriction, |
| | a time period (for example, | radio frequency selection, |
| | morning, evening, holiday, and | and a priority of radio |
| | weekend); and | frequency selection; and |
| | an analysis result of an | a UE policy: route |
| | NWDAF (for example, load level | selection and network |
| | information Load level | selection policies. |
| | information, service experience | For a corresponding |
| | Service experience, network | service scenario, the rule |
| | performance Network | may include the following: |
| | performance, and abnormal | a bandwidth control |
| | behavior Abnormal behavior). | parameter, a charging |
| | | action (for example, rate |
| | | A→rate B), a message |
| | | notification, redirection, |
| | | or the like. |
| Data (sensing data) | The input source of the | A standard sensing |
| | policy is xSSM. | “rule” is generated based |
| | The input information of | on a sensing service, and |
| | the policy may include but is not | the “rule” carries a QoS |
| | limited to the following: | parameter that is of a |
| | 1. a subscription body: an | sensing service and that is |
| | individual user, an enterprise | provided by a PCF for a |
| | user, and an operator; | user. The QoS parameter |
| | 2. content of subscription | of the sensing service may |
| | and subscription services may | include but is not limited |
| | include at least one of the | to at least one of the |
| | following: | following (of a sensing |
| | a sensing service package, a | area, a data collection |
| | sensing service monthly | source, and a |
| | package, a gift package offer (an | transmission path): |
| | offer quantity, duration, and the | 1. a sensing service |
| | like), a participation incentive | execution area, which may |
| | deduction manner, and the like; | include an area in which a |
| | 3. a sensing service type, | sensing entity that can |
| | which may include at least one | provide a service is |
| | of the following: | located, an accuracy- |
| | care for the elderly living | limited area, a forbidden |
| | alone, uncrewed aerial vehicle | area, and the like; |
| | track monitoring, a sensing | 2. a transmission |
| | map, and the like; | setting (service |
| | 4. an area location of a | perspective) of the |
| | sensed target, which may | sensing service, which |
| | include at least one of the | may include a maximum |
| | following: | threshold or a minimum |
| | a restricted area, an | threshold of a quantity of |
| | incentive provision area, and a | sensing entities, a |
| | single building/high-rise | maximum bandwidth of |
| | building; | the sensing service, a |
| | 5. a device type of a sensing | guarantee bandwidth of |
| | entity, which may include at | the sensing service, a |
| | least one of the following: | maximum/minimum |
| | a terminal (for example, a | execution periodicity of |
| | mobile phone or a vehicle) and a | the sensing service, a |
| | base station; | minimum/maximum |
| | 6. a user level, which may | delay of data |
| | include: common, VIP, or VVIP | transmission, a delay |
| | (for example, may be | difference range of |
| | dynamically updated based on | synchronous arrival of |
| | an NWDAF analysis result); | data of the sensing |
| | 7. a time period, which may | service, a deterministic |
| | include all day, busy hour, idle | delay of synchronous |
| | hour, holiday, and weekend; | arrival of the data of the |
| | 8. a type of sensing | sensing service, and a |
| | accuracy, which may include at | maximum data burst |
| | least one of the following: | volume; and |
| | positioning accuracy, speed | 3. a collection setting |
| | estimation accuracy, | of the sensing entity |
| | reconstruction/imaging | (collection policy): a |
| | accuracy, and sensing | minimum sensing signal |
| | resolution; | quantity for sensing |
| | 9. a missed detection | measurement, a |
| | probability and a false alarm | maximum/minimum |
| | probability; | collection time interval, |
| | 10. a sensing service delay; | and real-time or non-real- |
| | 11. an NWDAF analysis | time collection. |
| | result; | |
| | 12. sensing service | |
| | experience information, which | |
| | may include: insufficient | |
| | accuracy, frame freezing, an | |
| | untimely sensing result, and the | |
| | like; | |
| | 13. network performance | |
| | information, which may | |
| | include: a sensing data | |
| | transmission link becomes | |
| | worse or a fault occurs, or the | |
| | like; and | |
| | 14. an abnormal case of a | |
| | sensing entity, which may | |
| | include a sensing terminal is | |
| | powered off, a sensing signal is | |
| | poor, or the like. | |

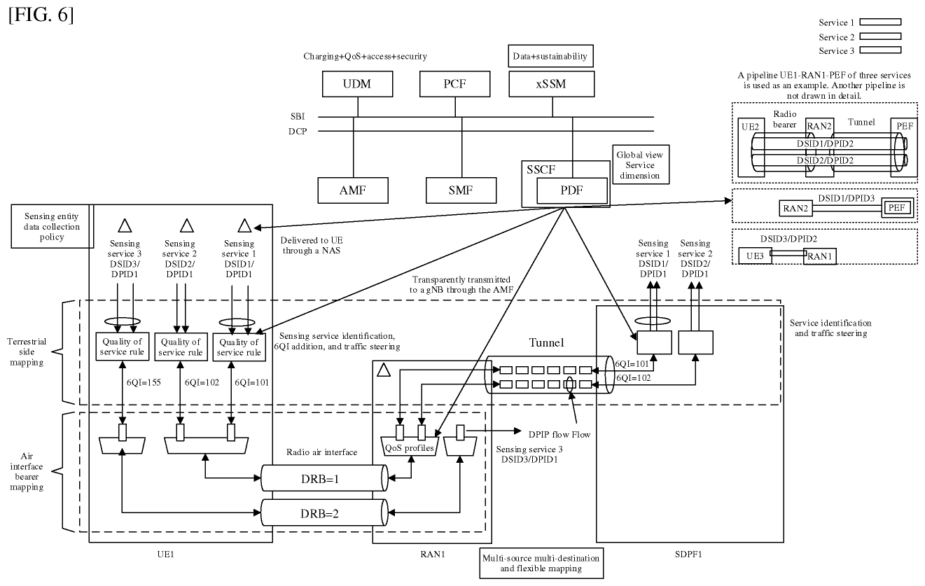

For example, based on FIG. 4, further, FIG. 6 is a specific diagram of sensing service data transmission in a sensing policy architecture according to an embodiment of this application. As shown in FIG. 6, for example, UE1 (built with a PEF) participates in three sensing services (for example, a sensing service 1, a sensing service 2, and a sensing service 3 in FIG. 6), and serves as a source node of the three sensing services; a sensing data processing function SDPF1 (built with a PEF) serves as a destination node of the sensing service 1 and the sensing service 2; and a RAN1 node (built with a PEF) serves as a destination node of the sensing service 3. From a left side, the SSCF (built with a PDF) sends a NAS message carrying a QoS value corresponding to a data pipeline of each service to the source node UE1, and sends a QoS value corresponding to a data pipeline of each service to the destination nodes (namely, the RAN1 node and SDPF1). In addition, the SSCF further delivers a quality of service rule QoS rule to UE1. The UE1 side performs service identification and traffic steering processing on collected data of the three sensing services based on the quality of service rule QoS rule (equivalent to a data packet filter), and adds a 6QI (QoS value). A data flow of each service is transmitted through a corresponding data pipeline. Air interface bearer mapping is performed on the UE1 side. To be specific, data pipelines of the three sensing services are mapped to two corresponding radio bearers. For example, a data pipeline of a sensing service 1 and a data pipeline of a sensing service 2 are mapped to a same radio bearer DRB1, and a data pipeline of a sensing service 3 is mapped to another radio bearer DRB2. Data of the three sensing services is transmitted to the RAN1 node through two radio air interfaces (which may also be referred to as DRB1 and DRB2). Because a destination node of the sensing service 3 is the RAN1 node, data of the sensing service 3 is no longer transmitted subsequently. For DRB1 that carries data of the sensing service 1 and data of the sensing service 2, the RAN1 node obtains two flows through division based on quality of service profiles QoS profiles (the QoS profiles include quality of service parameters, and are used by the RAN node to perform air interface processing), that is, a flow corresponding to the sensing service 1 and a flow corresponding to the sensing service 2, and the two flows are mapped to a tunnel corresponding to a data pipeline, and sent to SDPF1 (equivalent to that both a destination node PEF of the sensing service 1 and a destination node PEF of the sensing service 2 are deployed in SDPF1). Then, SDPF1 allocates a transmission resource (for example, a bandwidth, a delay, and a priority) to the flow of the sensing service 1 based on a QoS value corresponding to the data pipeline of the sensing service 1, and allocates a transmission resource (for example, a bandwidth, a delay, and a priority) to the flow of the sensing service 2 based on a QoS value corresponding to the data pipeline of the sensing service 2.

FIG. 6 is merely used as an example to describe an implementation of transmitting the data of the sensing service between the source node and the destination node. For an implementation of transmitting service data between another source node and another destination node or transmitting service data between a source node and a destination node of another service, refer to FIG. 6. Details are not described herein again.

The foregoing describes in detail the policy architecture provided in embodiments of this application. The policy architecture and the service scenario described in embodiments of this application are intended to describe the technical solutions in embodiments of this application more clearly, and do not constitute a limitation on the technical solutions provided in embodiments of this application. A person of ordinary skill in the art may know that with the evolution of the policy architecture and the emergence of new service scenarios, the policy architecture provided in embodiments of this application is also applicable.

In embodiments of this application, a part of scenarios is described by using a scenario of a 5G/6G communication network in a wireless communication network as an example. It should be noted that the solution in embodiments disclosed in this application may be further applied to another wireless communication network, and a corresponding name may also be replaced with a name of a corresponding function in the another wireless communication network.

The following describes the technical solutions in this application with reference to specific embodiments.

An embodiment of this application provides a sensing service policy determining method. The method may be applied to but is not limited to the policy architecture shown in FIG. 4. The method may be performed by a first function network element, a second function network element, and an execution node (for example, a first source node); or the method may be performed by a component (a module, a chip, or the like) corresponding to the first function network element, the second function network element, and the execution node; or the method may be performed by an apparatus correspondingly used together with the first function network element, the second function network element, and the execution node. It may be understood that a specific structure of an entity for performing the method provided in this embodiment of this application and a quantity of entities are not limited in this application, provided that a program that records code of the method provided in this embodiment of this application can be run to perform communication according to the method provided in this embodiment of this application. Interaction among the first function network element, the second function network element, and the first source node is used as an example for description below. A sequence of steps in the following procedures is merely an example. During actual application, the sequence of steps in the procedures may be adjusted.

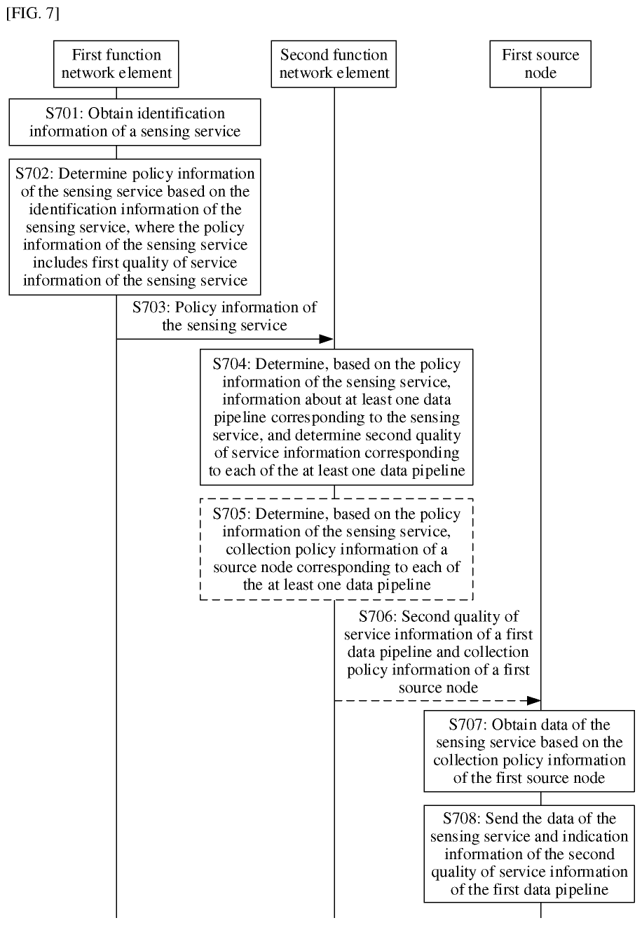

As shown in FIG. 7, a specific procedure of the method is as follows:

S701: The first function network element obtains identification information of a sensing service.

In this embodiment of this application, the first function network element may be deployed standalone in a network, or the first function network element is co-located with a policy control function network element in a network, or the first function network element may be a policy control function network element. This is not limited herein.

For example, the sensing service may include identification, speed measurement, ranging, and target positioning.

In a possible implementation, the identification information of the sensing service may correspond to user information of the sensing service (which is equivalent to that the identification information of the sensing service and the user information of the sensing service may be associated with each other), and the user information of the sensing service may include but is not limited to one more of user subscription information of the sensing service, user registration information of the sensing service, and service subscription information of the sensing service.

For example, the user subscription information or the service subscription information of the sensing service may include a sensing service package, a sensing service monthly package, a gift package offer (for example, an offer quantity and duration), and an incentive manner for participating in the sensing service. The user registration information of the sensing service may include user identity information, address information, user level information, and the like.

In a possible implementation, that the first function network element obtains the identification information of the sensing service and/or the user information of the sensing service includes: obtaining the identification information of the sensing service and/or the user information of the sensing service from a service user management network element of the sensing service. The service user management network element of the sensing service may be deployed standalone in a network, or the service user management network element of the sensing service is co-located with a data storage network element, or the service user management network element of the sensing service is the data storage network element. For example, the data storage network element may be a unified data management UDM network element.

For example, service user management (or the service user management network element) of the sensing service may be represented as xSSM, and x may represent a corresponding sensing service. For example, user management of the sensing service is represented as (sensing SSM, SSSM).

S702: The first function network element determines policy information of the sensing service based on the identification information of the sensing service, where the policy information of the sensing service includes first quality of service information of the sensing service.

For example, the user information, of the sensing service, corresponding to the identification information of the sensing service may be equivalent to the input information of the policy provided by the input source of the policy in Table 1. The policy information of the sensing service may be equivalent to the output of the policy in Table 1.

In a possible implementation, first quality of service of the sensing service may include but is not limited to one or more of the following:
a transmission delay of the sensing service, a maximum bandwidth of the sensing service, a guarantee bandwidth of the sensing service, an execution periodicity of the sensing service, a maximum data burst volume of the sensing service, a quantity of nodes participating in the sensing service, a time difference range of synchronous arrival of data of the sensing service, a deterministic delay of synchronous arrival of the data of the sensing service, and a priority of the sensing service.

For example, the transmission delay of the sensing service may include a maximum or minimum transmission delay supported for data/information of the sensing service, or a calculation delay. The maximum bandwidth of the sensing service may include: a maximum bandwidth (for example, a maximum uplink bandwidth or a maximum downlink bandwidth) occupied by the sensing service, a bandwidth type, and the like. The guarantee bandwidth of the sensing service may include: a bandwidth that guarantees normal execution of the sensing service, a minimum bandwidth of the sensing service, and the like. The execution periodicity of the sensing service may include a maximum periodicity, a minimum periodicity, or the like of executing the sensing service. The quantity of nodes participating in the sensing service may be a quantity of sensing entities that can participate in the sensing service. The time difference range of synchronous arrival of the data of the sensing service may be a range of a delay difference of arriving at a receiving end (for example, an SDPF) by collected sensing data reported by all sensing entities. The deterministic delay of synchronous arrival of the data of the sensing service may mean that a delay of arriving at the receiving end (for example, the SDPF) by the collected sensing data reported by all the sensing entities is within an allowed range. The priority of the sensing service may include a priority of transmitting or processing the data/information of the sensing service, and the like.

In a possible implementation, the policy information of the sensing service may further include one or more of execution range information of the sensing service and collection policy information of the sensing service.

In this embodiment of this application, an execution range of the sensing service may be a network area in which the sensing service is executed, or may be a candidate node corresponding to the sensing service, or may be a candidate data pipeline corresponding to the sensing service. This is not limited herein. In addition, none of a quantity of network areas in which the sensing service is executed, a quantity of candidate nodes corresponding to the sensing service, and a quantity of candidate pipelines corresponding to the sensing service is limited. Therefore, the execution range information of the sensing service may include but is not limited to one or more of information about a network area, information about a candidate node, and information about a candidate data pipeline that are of the sensing service. A display form of the execution range information of the sensing service may be information, a list, or the like.

For example, the execution range information of the sensing service is a list of network areas in which the sensing service is executed, and the list may include one or more areas.

In this embodiment of this application, the collection policy information of the sensing service may indicate a collection channel, a collection manner, and the like of the data/information of the sensing service. In a possible implementation, the collection policy information of the sensing service may include but is not limited to at least one of the following: a minimum sensing signal used for sensing measurement, a data collection time interval, and real-time or non-real-time data collection.

In this embodiment of this application, the policy information, of the sensing service, determined by the first function network element may further include one or more of forwarding policy information of the sensing service, computing policy information of the sensing service, security policy information of the sensing service, and the like. This is not limited herein.

For example, the forwarding policy information of the sensing service may provide a composition policy for implementing a data bearer of the sensing service, and may include topology information such as a source node, a destination node, an intermediate node, and a data pipeline, and policies such as bandwidth and a delay required for data flowing. The computing policy information of the sensing service may include an algorithm or a method used for computing, a participating node for computing, time consumed for computing, and the like. The security policy information of the sensing service may include integrity of the sensing service, whether to perform privacy protection on the data/information of the sensing service, and the like.

S703: The first function network element sends the policy information of the sensing service to the second function network element. Correspondingly, the second function network element receives the policy information of the sensing service.

In this embodiment of this application, the second function network element may be deployed standalone in a core network, an access network, or a network management system, or the second function network element is co-located with a first service network element. The first service network element may be but is not limited to any one of the following:
a data controller DC (for example, a DC in the access network or a DC in the core network), a sensing service control function, a task anchor, and a task scheduler.

S704: The second function network element determines, based on the policy information of the sensing service, information about at least one data pipeline corresponding to the sensing service, and determine second quality of service information corresponding to each of the at least one data pipeline.

In this embodiment of this application, the at least one data pipeline may be used to carry or transmit the data and/or information of the sensing service, and the like.

In a possible implementation, the policy information of the sensing service further includes the execution range information of the sensing service, and the method may further include: The second function network element obtains status information of a network and/or status information of a node within the execution range of the sensing service based on the execution range information of the sensing service.

In S704, that the second function network element determines, based on the policy information of the sensing service, the information about the at least one data pipeline corresponding to the sensing service may include: The second function network element determines, based on the policy information of the sensing service, and the status information of the network, the status information of the node, and/or capability information of the node, information about a destination node and the information about the source node that correspond to each of the at least one data pipeline.

That the second function network element determines, based on the policy information of the sensing service, second quality of service information corresponding to each of the at least one data pipeline may include: The second function network element determines, based on the policy information of the sensing service, and the status information of the network, the status information of the node, and/or the capability information of the node, the second quality of service information corresponding to each of the at least one data pipeline.

In this embodiment of this application, when the execution range information of the sensing service in S702 includes information about the network area of the sensing service, the second function network element may obtain, based on the information about the network area of the sensing service, status information (for example, one or more of network load, link load, and link robustness) of a network in the network area and/or status information of each node in the network area (for example, one or more of load of the node, whether the node is occupied, and robustness of the node). In an embodiment, the second function network element further obtains capability information (for example, one or more of a sensing capability and a computational capability) of each node in the network area, and a capability of each node may be reported by each node to the second function network element in advance or known by the second function network element. This is not limited herein.

For a case in which the execution range information of the sensing service includes the information about the candidate node corresponding to the sensing service, the second function network element may obtain status information (for example, one or more of load of the node, whether the node is occupied, and robustness of the node) of the candidate node based on the information about the candidate node corresponding to the sensing service. In an embodiment, the second function network element further obtains capability information (for example, a sensing capability and a computational capability) of the candidate node. Similarly, capability information of each node may be reported by each node to the second function network element in advance or known by the second function network element. This is not limited herein.

When the execution range information of the sensing service includes the information about the candidate pipeline corresponding to the sensing service, the second function network element may obtain, based on the information about the candidate pipeline corresponding to the sensing service, status information of each node (for example, one or more of a source node, an intermediate node, and a destination node) corresponding to at least one candidate data pipeline, status information of each node, and/or capability information of each node (a channel for obtaining the capability information of the node is similar to the foregoing), and may further obtain the status information of the candidate data pipeline (for example, one or more of load, robustness, and a transmission direction of the data pipeline).

In conclusion, the second function network element may flexibly obtain the status information of the network and/or the status information of the node within the execution range of the sensing service based on the actual policy information of the sensing service. This is not limited herein.

In this embodiment of this application, information about each data pipeline may include information about at least one destination node and information about at least one source node. In this embodiment of this application, an example in which the data pipeline corresponds to one destination node and one source node is used to describe the solution. In an embodiment, the information about the data pipeline may further include information about at least one intermediate node, and/or identification information (for example, a DPID) of the data pipeline. For example, information about a node may be address information of the node, or identification information of the node.

In this embodiment of this application, the source node, the destination node, or the intermediate node each may be considered as a policy enforcement function network element. The policy enforcement function network element may be deployed standalone in the network and serve a second service network element, or the policy enforcement function network element may be deployed in a second service network element. The second service network element may be but is not limited to a terminal/terminal device, a radio access network node, an access and mobility management function, a session management function, a unified data repository, a user plane function, or a sensing data processing function.

In this embodiment of this application, the second quality of service information corresponding to each data pipeline may include but is not limited to at least one of a transmission delay of the data pipeline, a maximum bandwidth of the data pipeline, a guarantee bandwidth of the data pipeline, a transmission execution periodicity of the data pipeline, a maximum data burst volume of the data pipeline, a quantity of nodes participating in the sensing service on the data pipeline, a delay difference range of synchronous arrival of data of the data pipeline, a deterministic delay of synchronous arrival of data of the data pipeline, and a priority of the data pipeline. The second quality of service information corresponding to each data pipeline includes more specific and detailed content or information than the first quality of service information of the sensing service.

S705: The second function network element determines, based on the policy information of the sensing service, collection policy information of a source node corresponding to each of the at least one data pipeline. S705 is an optional step. In some embodiments, S705 and S704 may be performed simultaneously.

In a possible implementation, the policy information of the sensing service further includes the collection policy information of the sensing service, and that the second function network element performs S705 may include: The second function network element determines, based on the collection policy information of the sensing service, the collection policy information of the source node corresponding to each of the at least one data pipeline.

In a possible implementation, the second function network element may determine, based on the collection policy information of the sensing service, and the status information of the network, status information of each node, and/or capability information of each node within the execution range of the sensing service, the collection policy information of the source node corresponding to each of the at least one data pipeline.

For example, the collection policy information of the source node may include but is not limited to one or more of the following: a minimum sensing signal used for sensing measurement, a data collection time interval of the source node, and real-time or non-real-time data collection of the source node.

In this embodiment of this application, the second function network element may further determine, based on the forwarding policy of the sensing service, the computing policy information of the sensing service, the security policy information of the sensing service, and the like in the policy information of the sensing service, forwarding policy information, computing policy information, security policy information, and the like that correspond to each data pipeline. Details are not described herein again.

In a possible implementation, the method may further include: The second function network element sends, based on the information about the source node corresponding to each of the at least one data pipeline, the corresponding second quality of service information and the corresponding collection policy information of the source node to the source node corresponding to the at least one data pipeline. For example, the information about the source node may be one or more of address information, identification information, and the like of the source node.

In a possible implementation, the method may further include: When a first source node of a first data pipeline moves out of the execution range of the sensing service, the second function network element may determine a second node in the execution range of the sensing service, and use the second node as a source node of the first data pipeline, to obtain an updated first data pipeline. The first data pipeline is any one of the at least one data pipeline corresponding to the sensing service.

In a possible implementation, the method may further include: The second function network element determines quality of service information corresponding to the updated first data pipeline and collection policy information of the second node; and sends the quality of service information corresponding to the updated first data pipeline and the collection policy information of the second node to the second node.

S706 to S708 describe, by using the first source node of the first data pipeline as an example, a solution performed by the source node. The first data pipeline may be one of the at least one data pipeline corresponding to the sensing service. For another source node of the first data pipeline or a source node of another data pipeline, refer to an implementation of the first source node. Details are not described in this application again.

S706: The second function network element sends second quality of service information of the first data pipeline and collection policy information of the first source node to the first source node. Correspondingly, the first source node receives the second quality of service information of the first data pipeline and the collection policy information of the first source node.

S706 is an optional step.

S707: The first source node obtains the data of the sensing service based on the collection policy information of the first source node.

S708: The first source node sends the data of the sensing service and indication information of the second quality of service information of the first data pipeline.

In this embodiment of this application, the indication information of the second quality of service information of the first data pipeline is, for example, one or more of an identifier, a label, and a name of the quality of service information). The data of the sensing service and the indication information of the second quality of service information of the first data pipeline may be sent in a same data packet or message, or may be sent in different data packets/messages. This is not limited herein. In addition, the indication information of the quality of service information of the first data pipeline may be a value corresponding to the quality of service information of the first data pipeline, or may be identification information (for example, an identifier ID, a label, or a name) used to identify the quality of service information of the first data pipeline. This is not limited either.

In this embodiment of this application, that the first source node sends the data of the sensing service and the indication information of the second quality of service information of the first data pipeline may include but is not limited to the following several implementations:

Implementation 1: When the first source node is deployed in a first radio access network node, that the first source node sends the data of the sensing service and the indication information of the second quality of service information of the first data pipeline may include: sending the data of the sensing service and the indication information of the second quality of service information of the first data pipeline to a second radio access network node or a core network element through the first communication tunnel. The second radio access network node (or the core network element) may be a destination node or an intermediate node corresponding to the first data pipeline.

In this embodiment of this application, at least one communication tunnel (including the first communication tunnel) may be established in advance, or may be established in real time. This is not limited herein. The first source node may find, through matching, a corresponding communication tunnel based on the quality of service information of the first data pipeline. For example, the first source node maps the first data pipeline to the corresponding first communication tunnel.

For example, at least one communication tunnel (including the first communication tunnel) is preset, and the at least one communication tunnel each correspond to a quality of service QoS value or a quality of service QoS range. If a quality of service QoS value of the first data pipeline is a quality of service QoS value corresponding to the first communication tunnel, or a quality of service QoS value of the first data pipeline falls within a quality of service QoS range corresponding to the first communication tunnel, it is determined that a communication tunnel matching the first data pipeline is the first communication tunnel.

In a possible implementation, the first communication tunnel may further correspond to a second data pipeline, and the second data pipeline is used to carry/transmit data of another service.

In this embodiment of this application, data pipelines of a same service may correspond to a same communication tunnel, or may correspond to different communication tunnels, and data pipelines of different services may correspond to different communication tunnels, or may correspond to a same communication tunnel. This is not limited herein.

Implementation 2: When the first source node is deployed in a terminal/terminal device, that the first source node sends the data of the sensing service and the indication information of the second quality of service information of the first data pipeline may include: sending the data of the sensing service and the indication information of the second quality of service information of the first data pipeline to a radio access network node through the first data radio bearer. The radio access network node may be a destination node or an intermediate node corresponding to the first data pipeline.

In this embodiment of this application, at least one data radio bearer (including the first data radio bearer) may be established in advance, or may be established in real time. This is not limited herein. The first source node may find, through matching, a corresponding data radio bearer based on the quality of service information of the first data pipeline. For example, the first source node maps the first data pipeline to the corresponding first data radio bearer.

For example, at least one data radio bearer (including the first data radio bearer) is preset, and at least one data radio bearer each correspond to a quality of service QoS value or a quality of service QoS range. If a quality of service QoS value of the first data pipeline is a quality of service QoS value corresponding to the first data radio bearer, or a quality of service QoS value of the first data pipeline falls within a quality of service QoS range corresponding to the first data radio bearer, it is determined that a data radio bearer matching the first data pipeline is the first data radio bearer.

In a possible implementation, the first data radio bearer may further correspond to a second data pipeline, and the second data pipeline is used to carry/transmit data of another service.

In this embodiment of this application, data pipelines of a same service may correspond to a same data radio bearer, or may correspond to different data radio bearers, and data pipelines of different services may correspond to different data radio bearers, or may correspond to a same data radio bearer. This is not limited.

In a possible implementation, the method may further include: When a first source node of a first data pipeline leaves or is out of the execution range of the sensing service, the second function network element determines a second node in the execution range of the sensing service, and uses the second node as a source node of the first data pipeline, to obtain an updated first data pipeline. The first data pipeline is any one of the at least one data pipeline.

In a possible implementation, the method may further include: The second function network element determines second quality of service information corresponding to the updated first data pipeline and collection policy information of the second node; and sends the second quality of service information corresponding to the updated first data pipeline and the collection policy information of the second node to the second node.

In this embodiment of this application, identification information of the updated first data pipeline may be the identification information of the first data pipeline, or may be identification information of a new data pipeline. This is not limited herein.

In conclusion, this embodiment of this application provides a sensing service policy determining method. The method includes: The first function network element obtains the identification information of the sensing service; and determines the policy information of the sensing service based on the identification information of the sensing service. The policy information of the sensing service includes the first quality of service information of the sensing service. Then, the first function network element sends the policy information of the sensing service to the second function network element. It can be learned that in the method, the first function network element determines the policy information of the sensing service from a service perspective, to provide the quality of service information of the sensing service, which can also be applied to an evolved communication network, so that a policy requirement of the sensing service can be effectively met.

Based on the sensing service policy determining method described in FIG. 7, the following further describes in detail by using several specific implementations.

### Implementation 1:

In Implementation 1, based on the method in FIG. 7, a procedure of determining a policy of a sensing service is described in detail. As shown in FIG. 8A-1 to FIG. 8A-3, the procedure of determining the policy of the sensing service is as follows:

S801A: A user requester performs user subscription registration and service subscription with SSSM.

The user requester registers with SSSM, subscribes to the sensing service, and obtains authorization of a sensed party.

For example, SSSM is a function or a network element that provides a user management service for the sensing service.

For example, a process in which the user requester registers with and subscribes to SSSM and subscribes to a service may include the following steps:

Step 1: The user requester sends user registration request information to SSSM.

Step 2: SSSM verifies a user qualification and creates a customer.

In step 2, SSSM may generate user level information.

Step 3: SSSM sends registration request confirmation information to the user requester.

Step 4: The user requester sends a sensing service subscription request information to SSSM.

Step 5: SSSM generates an identifier (ID) of the sensing service, a sensing service type, an area, the policy of the sensing service, and the like based on the sensing service subscription request information. The policy of the sensing service may include one or more of information about an area in which the sensing service is executed (for example, an area in which an entity that may provide the sensing service is located), a transmission policy (for example, a maximum bandwidth, a guarantee bandwidth, a maximum repetition period, and a minimum delay), a collection policy (for example, a quantity of measurement and sensing signals, a maximum time interval, and real-time/non-real-time), and a forwarding policy (for example, topology information such as a source node, a destination node, an intermediate node, and a data pipeline, and a bandwidth and delay required for data flowing).

Step 6: SSSM sends sensing service subscription request confirmation information to the user requester, to notify the user requester that sensing service subscription succeeds.

S801A belongs to an initial phase. In the initial phase, each sensing entity further needs to report a sensing capability of the sensing entity to an SSCF.

In Implementation 1, S801A may alternatively be completed offline.

S802A: The user requester sends request information of the sensing service to the SSCF. Correspondingly, the SSCF receives the request information of the sensing service.

In an embodiment, the request information of the sensing service may include the ID of the sensing service (an example of the identification information of the sensing service in the solution in FIG. 7).

S803A: The SSCF sends request information of user subscription information to SSSM. Correspondingly, SSSM receives the request information of the user subscription information.

In an embodiment, the request information of the user subscription information may include the ID of the sensing service, or information about the user requester (for example, a name or an ID of the user requester).

S804A: SSSM sends subscription information of the user requester to the SSCF. Correspondingly, the SSCF receives the subscription information of the user requester.

The SSCF obtains the subscription information (sensing service subscription information) of the user requester, and may further obtain location information carried when the user requester goes online, and the like.

S805A: The SSCF sends user information (an example of the user information of the sensing service in the solution in FIG. 7) to the PCF.

The user information includes the subscription information (for example, the sensing service subscription information) of the user requester, the location information carried when the user requester goes online, and the like.

S806A: The PCF generates the policy (an example of the policy information of the sensing service in the solution in FIG. 7) of the sensing service based on the user information.

The policy, of the sensing service, generated by the PCF may include one or more of a collection area (an example of the execution range information of the sensing service in the solution in FIG. 7) of data of the sensing service, a collection setting (an example of the collection policy information of the sensing service in the solution in FIG. 7) of a sensing entity, and a parameter setting (an example of the first quality of service information of the sensing service in the solution in FIG. 7) of a data pipeline used to transmit sensing data.

The collection area (an example of the execution range information of the sensing service in the solution in FIG. 7) of the data of the sensing service may include one or more of an area in which a sensing entity that may provide a service is located, an accuracy-limited area, a forbidden area, and the like.

The collection setting (an example of the collection policy information of the sensing service in the solution described in FIG. 7) of the sensing entity (or a data source) may include one or more of a minimum/maximum quantity of sensing signals used for sensing measurement, a minimum/maximum data collection time interval, real-time or non-real-time data collection, and the like.

The parameter setting (an example of the first quality of service information of the sensing service in the solution in FIG. 7) of the data pipeline used to transmit data may include one or more of a maximum bandwidth (or a total bandwidth) of data transmission, a guarantee bandwidth, a periodicity of sensing detection or data collection, a minimum delay of data transmission, and the like.

S807A: The PCF sends the policy of the sensing service to the SSCF. Correspondingly, the SSCF receives the policy of the sensing service.

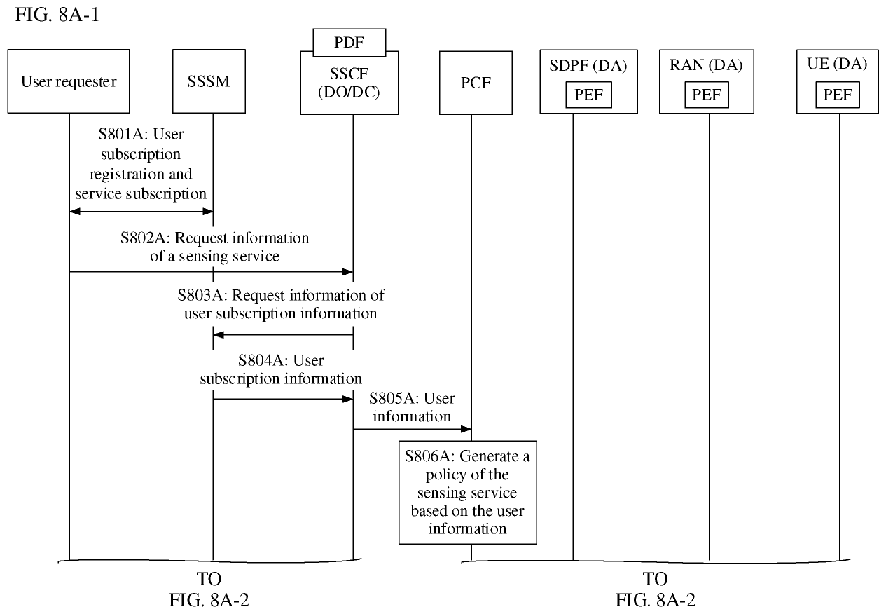

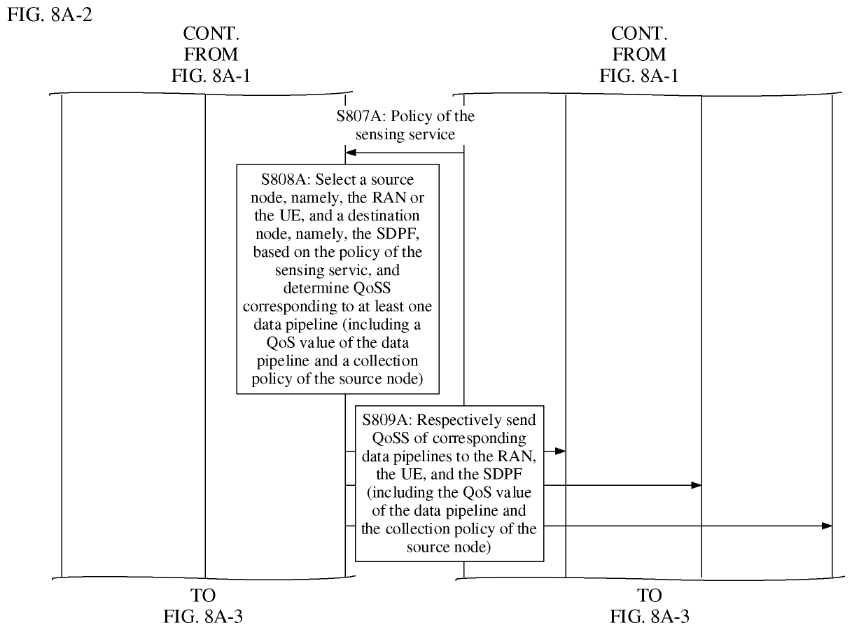

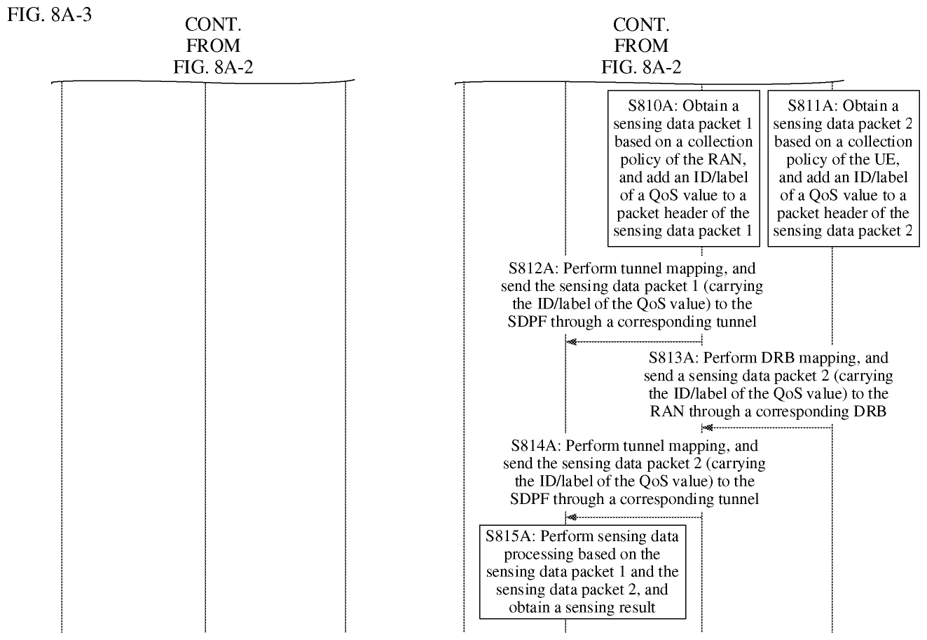

As shown in FIG. 8B, the SSCF is equivalent to a DO/DC in a data plane function architecture, a PDF may be integrated or built in a sensing service control function SSCF, and a PEF may be integrated or built in an SDPF, a RAN node (for example, a RAN1 node, a RAN2 node, or a RAN3 node), and UE (for example, UE1 or UE2). The SDPF may be configured to collect sensing data of another node (for example, UE1, UE2, or the RAN3 node), process the sensing data to obtain sensing result data, and then report the sensing result data together.

S808A: The SSCF selects a source node RAN or UE, and a destination node SDPF based on the policy of the sensing service, and determines a QoSS corresponding to at least one data pipeline, where each QoSS includes quality of service of the data pipeline and a collection policy corresponding to the source node.

It should be noted that, in this embodiment of this application, an example in which quality of sensing service (QoSS) corresponding to the data pipeline may include quality of service QoS of the data pipeline and a collection policy corresponding to the source node is used for description. In another possible implementation, QoSS corresponding to each data pipeline is/includes quality of service QoS of the data pipeline, and does not include a collection policy corresponding to the data pipeline. In this case, the SSCF not only needs to send the QoSS of the corresponding data pipeline to each source node, but also needs to send a corresponding collection policy to each source node, or the SSCF includes the quality of service QoS of each data pipeline and the collection policy of the corresponding source node in a same message, and sends the message to the corresponding source node.

In a possible implementation, the SSCF (integrated or built with the PDF) selects a proper source node (for example, the RAN node or the UE) and a proper destination node (for example, the SDPF) based on the status information of the network, and status information and/or capability information of each node within the execution range of the sensing service, designs at least one data pipeline, determines a source node and a destination node (which may further include an intermediate node) that correspond to each data pipeline and a QoS value of each data pipeline, and further determines a collection policy of the source node (for example, a RAN node or a UE) corresponding to each data pipeline.

For example, the SSCF (integrated or built with the PDF) may orchestrate and generate a data bearer and a specific policy part based on a sensing service data collection area provided by the PCF and sensing capability information reported by each sensing entity in the collection area, which may include the following:
(1) selecting the sensing entity (that is, selecting the source node, the destination node, or the like); (2) a transmission setting (that is, determining the QoSS corresponding to the data pipeline) in a service perspective, for example, determining a quantity of data pipelines, an identifier (DPID) of each data pipeline, and a transmission parameter value (for example, a QoS value corresponding to each data pipeline) corresponding to each data pipeline, selecting, from the sensing entity, the source node and the destination node corresponding to each data pipeline, and the like; (3) determining a specific collection setting (that is, a collection policy of the source node corresponding to each data pipeline) of each sensing entity, which may include one or more of a quantity of measurement and sensing signals, a collection time interval, real-time or non-real-time collection, and the like.

For example, as shown in FIG. 8B, for a sensing service 1 (with an identifier DSID1), the SSCF (integrated or built with the PDF) selects a proper source node (for example, UE1, UE2, or the RAN3 node) and a proper destination node (for example, the SDPF) based on the collection area of the data of the sensing service in the policy of the sensing service provided by the PCF and the sensing capability information reported by each sensing entity in the collection area, and determines three data pipelines, identifiers of the three data pipelines are DPID1, DPID2, and DPID3. A source node corresponding to a data pipeline (UE1-RAN1 node-SDPF) with the identifier DPID1 is UE1, an intermediate node is the RAN1 node, and a destination node is the SDPF. A source node corresponding to a data pipeline (UE2-RAN2 node-SDPF) with the identifier DPID2 is UE2, an intermediate node is the RAN2 node, and a destination node is the SDPF. A source node corresponding to a data pipeline (RAN3 node-SDPF) with an identifier DPID3 is the RAN3 node, and a destination node is the SDPF. The SSCF (integrated or built with the PDF) may further determine a corresponding quality of service QoS value for each of the three data pipelines based on a quality of service QoS value that is of the sensing service and that is provided by the PCF, and may determine a collection setting (or a collection policy) of each source node (for example, UE1, UE2, and the RAN3 node) based on a collection setting (or a collection policy) that is of the sensing service and that is provided by the PCF.

The PCF is an example of the first function network element in the solution in FIG. 7, and the SSCF is an example of the second function network element in the solution in FIG. 7.

S809A: The SSCF (built or integrated with the PDF) sends QoSS corresponding to the data pipelines to the RAN, the UE, and the SDPF, where each QoSS includes a QoS value corresponding to the data pipeline and a collection policy corresponding to the source node.

For example, the SSCF (built or integrated with the PDF) may deliver quality of service of each data pipeline to a corresponding source node and a corresponding destination node (for example, the SDPF) based on an M&A mechanism, deliver a collection policy of the source node RAN node to the RAN node, and deliver a collection policy of a source node UE to the UE. In an embodiment, the SCCF (built or integrated with the PDF) may further deliver the QoSS of each data pipeline to at least one corresponding intermediate node.

For example, as shown in FIG. 8B, the SSCF (integrated or built with the PDF) determines that the data pipeline with the identifier DPID1 corresponds to QoSS1 (including a quality of service QoS value 1 of the data pipeline with DPID1 and a policy 1 of the source node UE1); the SSCF (integrated or built with the PDF) determines that the data pipeline with the identifier DPID2 corresponds to QoSS2 (including a quality of service QoS value 2 of the data pipeline with DPID2 and a collection policy 2 of the source node UE2); and the SSCF (integrated or built with the PDF) determines that the data pipeline with the identifier DPID3 corresponds to QoSS3 (including a quality of service QoS value 3 of the data pipeline with DPID3 and a collection policy 3 of the source node RAN3 node).

Further, the SSCF (integrated or built with the PDF) separately sends the quality of service QoS value 1 of the data pipeline with DPID1 to UE1 and the RAN1 node, and further sends the collection policy 1 to UE1. The SSCF (integrated or built with the PDF) separately sends the quality of service QoS value 2 of the data pipeline with DPID2 to UE2 and the RAN2 node, and further sends the collection policy 2 to UE2. The SSCF (integrated or built with the PDF) separately sends the quality of service QoS value 3 of the data pipeline with DPID3 and the collection policy 3 to RAN3. Because the SDPF serves as a common destination node of the three data pipelines, the SSCF (integrated or built with the PDF) sends the quality of service QoS value 1 of the data pipeline with DPID1, the quality of service QoS value 2 of the data pipeline with DPID2, and the quality of service QoS value 3 of the data pipeline with DPID3 to the SDPF.

In an embodiment, alternatively, the SSCF (integrated or built with the PDF) may separately send the identifier DPID1 of the corresponding data pipeline to UE1 and the RAN1 node, separately send the identifier DPID2 of the corresponding data pipeline to UE1 and the RAN2 node, send the identifier DPID3 of the corresponding data pipeline to the RAN3 node, and further send the identifiers DPID1, DPID2, and DPID3 of the three data pipelines to the SDPF.

In this application, the SSCF (integrated or built with the PDF) sends QoSS to nodes corresponding to the data pipelines. A time sequence of the collection policy of the source node and the identifier of the data pipeline may be flexibly set. This is not limited.

S810A: The RAN node obtains a sensing data packet 1 based on a collection policy of the RAN, and adds an ID/label of a QoS value to a packet header of the sensing data packet 1.

S811A. The UE obtains the sensing data packet 2 based on the collection policy of the UE, and adds an ID/label of a QoS value to a packet header of the sensing data packet 2.

S810A and S811A may be performed synchronously, or may not be performed synchronously, and an execution sequence is not limited.

S812A: The RAN node performs tunnel mapping, and sends a sensing data packet 1 (carrying the ID/label of the QoS value) to the SDPF through a corresponding tunnel.

S813A: The UE performs DRB mapping, and sends a sensing data packet 2 (carrying the ID/label of the QoS value) to the RAN through a corresponding DRB.

S812A and S813A may be performed synchronously, or may not be performed synchronously, and an execution sequence is not limited.

S814A: The RAN node performs tunnel mapping, and sends the sensing data packet 2 (carrying the ID/label of the QoS value) to the SDPF through a corresponding tunnel.

S815A: The SDPF performs sensing data processing based on the sensing data packet 1 and the sensing data packet 2, and obtains a sensing result.

For example, as shown in FIG. 8B, after executing a sensing task based on QoSS1 corresponding to the data pipeline with DPID1, UE1 obtains the sensing data packet 1, and adds an identifier/label of QoSS1 to the packet header of the sensing data packet 1. UE1 performs air interface mapping on the sensing data packet 1 (carrying the identifier/label of QoSS1), and sends the sensing data packet 1 to the RAN1 node. Then, the RAN1 node performs tunnel mapping, and sends the sensing data packet 1 to the SDPF. After executing a sensing task based on QoSS2 corresponding to the data pipeline with DPID2, UE2 obtains the sensing data packet 2, and adds an identifier/label of QoSS2 to the packet header of the sensing data packet 2. UE2 performs air interface mapping on the sensing data packet 2 (carrying the identifier/label of QoSS2), and sends the sensing data packet 2 to the RAN2 node. Then, RAN2 performs tunnel mapping, and sends the sensing data packet 2 to the SDPF. After executing a sensing task based on QoSS3 corresponding to the data pipeline with DPID3, the RAN3 node obtains the sensing data packet 3, and adds an identifier/label of QoSS3 to the packet header of the sensing data packet 3. The RAN3 node performs tunnel mapping on the sensing data packet 3 (carrying the identifier/label of the QoSS3), and sends the sensing data packet 3 to the SDPF.

The SDPF may perform sensing data processing based on the sensing data packet 1, the sensing data packet 2, and the sensing data packet 3, and obtain a sensing result.

Further, the SDPF sends the sensing result (for example, measurement data or raw data) to an application function AF, and the application function AF forwards the sensing result to a user requester. In addition, the PDF in the PCF and/or the SSCF may also dynamically update the policy based on the sensing result.

In addition, the SSCF may delete information about the data bearer after confirming that the sensing task is completed.

In Implementation 1, the policy architecture provided in embodiments of this application is applied to a network scenario of the sensing service, so that a policy can be effectively formulated for the sensing service, and the policy of the sensing service can be effectively implemented.

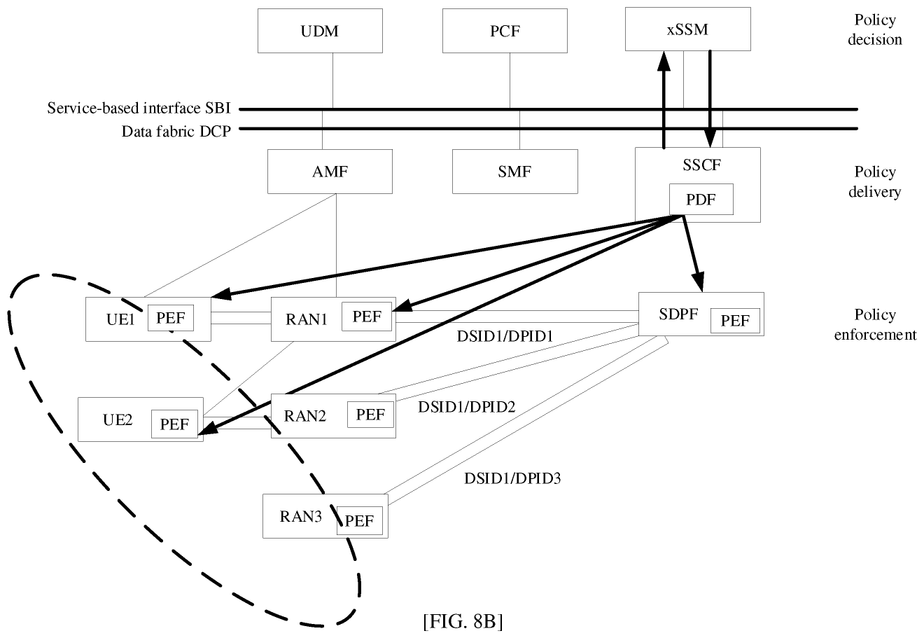

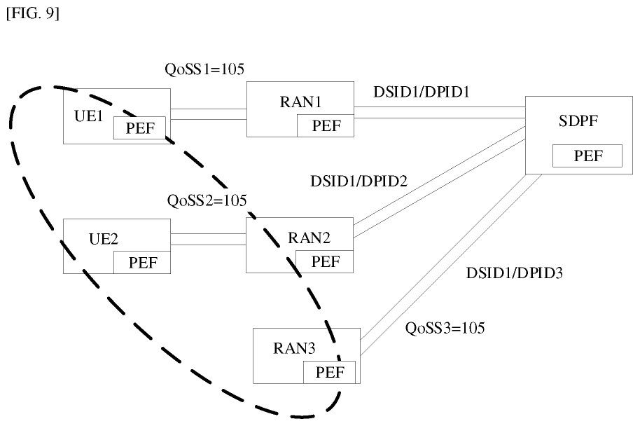

Implementation 2: Based on the solutions in FIG. 7 and FIG. 8A-1 to FIG. 8A-3 and the example in FIG. 8B, how a PDF in an SSCF determines, based on policy information that is of a sensing service and that is provided by a PCF, specific policy information corresponding to each node and a data pipeline is described. A sensing service 1 is used as an example. The sensing service 1 is used to represent a sensing service, and has an identifier DSID1. For a network topology corresponding to the sensing service 1, refer to FIG. 9. The PDF in the SSCF determines or generates specific policy information of each node and the data pipeline, which may include the following:

### (1) Select a Proper Sensing Entity, and Design a Data Pipeline.

For example, as shown in FIG. 9, the PDF in the SSCF selects sensing entities UE1, UE2, and a RAN3 node, and designs three data pipelines. Identifiers respectively corresponding to the three data pipelines are DPID1, DPID2, and DPID3. UE1, UE2, and the RAN3 node serve as source nodes (or data sources) corresponding to the three data pipelines.

### (2) Set a Transmission Parameter of Each Data Pipeline.

For example, as shown in FIG. 9, a minimum sensing entity quantity determined by the PDF in the SSCF is 3. If a QoSS value that is of the sensing service 1 (the sensing service 1 indicates a sensing service) and that is provided by the PCF is 105, the PDF in the SSCF may determine, based on the QoSS value 105 of the sensing service 1, that QoSS values of the three data pipelines are 105.

For example, when the QoSS value is predefined as 105, it indicates that a corresponding bandwidth is 10 M and a delay is 10 ms; or when a QoSS value is predefined as 90, it indicates that a corresponding bandwidth is 100 M and a delay is 1 ms.

When the QoSS value of the sensing service 1 is 105, it indicates that a bandwidth that is of the sensing service 1 and that is provided by the PCF is 10 M, and a delay is 10 ms. In this case, the PDF in the SSCF may determine, based on the bandwidth 10 M of the sensing service 1, that a data pipeline with DPID1 and a data pipeline with DPID2 each are 3 M, and a data pipeline with DPID3 is 4 M. In addition, the PDF in the SSCF determines that a synchronization delay difference among data of UE1, UE2, and the RAN3 node separately arriving at the SDPF does not exceed 10 ms.

### (3) Set a Collection Policy Corresponding to Each Data Pipeline.

For example, setting the collection policy corresponding to each data pipeline may include the following:

Content collected by each sensing entity (for example, UE1, UE2, or the RAN3 node) is set. For example, the collected content may include a part or all of collected surrounding physical environment information (for example, the surrounding physical environment information is used to construct a virtual environment), surrounding channel information (for example, the surrounding channel information is used to assist communication), an action/behavior of a collector or an animal, a heartbeat, and the like.

Each sensing entity (for example, UE1, UE2, or the RAN3 node) is set to collect a sensing signal (for example, an I/Q signal) in real time.

A collection interval of each sensing entity is set. For example, a collection interval of each of UE1 and UE2 is set to 100 ns, and a collection interval of the RAN3 node is set to 10 ns.

It can be learned from Implementation 2 that, the PDF in the SSCF may flexibly topologize or orchestrate, based on a policy of the sensing service, a data pipeline used to transmit sensing data, and can further formulate more refined policy information for the data pipeline, so that a flexible policy requirement can be met.

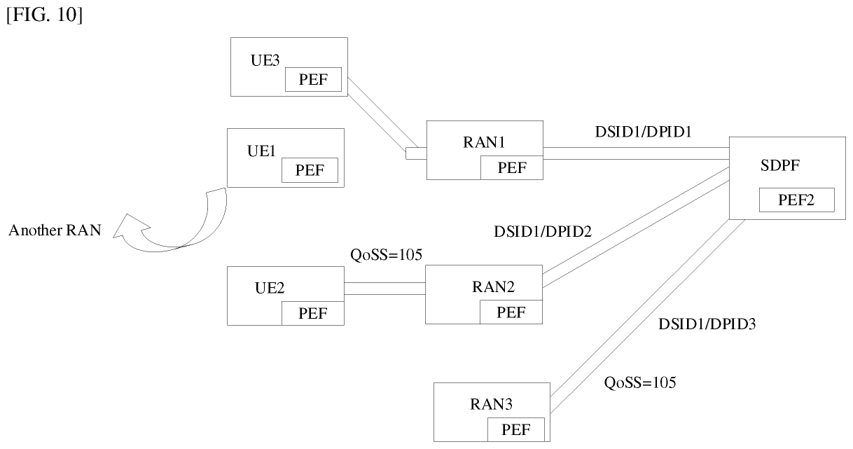

Implementation 3: Based on the solutions in FIG. 7 and FIG. 8A-1 to FIG. 8A-3 and the example in FIG. 8B, how a PDF in an SSCF updates policy information corresponding to a data pipeline when a location of a sensing entity corresponding to the data pipeline changes is described. A sensing service 1 is used as an example. The sensing service 1 is used to represent a sensing service, and has an identifier DSID1. For a network topology corresponding to the sensing service 1, refer to FIG. 10. How the PDF in the SSCF updates the policy information corresponding to the data pipeline when the location of the sensing entity corresponding to the data pipeline changes may include the following:

Policy information of the sensing service 1 requires that a minimum sensing entity quantity be 3, and a service bandwidth remains unchanged. If a sensing entity UE1 corresponding to a data pipeline with DPID1 moves out of a range of a RAN1 node currently, for example, UE1 is handed over from the RAN1 node to another RAN node, the PDF in the SSCF needs to determine a new sensing entity (for example, UE3) to replace UE1, and update policy information of the data pipeline with DPID1, to meet a policy requirement of the sensing service 1.

For example, a process in which the PDF in the SSCF updates the policy information of the data pipeline with DPID1 may include the following:
(1) When the sensing entity UE1 is handed over from the RAN1 node to another RAN node, the PDF in the SSCF may reselect, based on the policy requirement, other UE (assumed to be UE3) managed by the RAN1 node to replace UE1, and use a new identifier DPID4 to replace DPID1 to identify an updated data pipeline. For the updated data pipeline (with DPID4), refer to FIG. 10. Alternatively, the SSCF may use the original identifier DPID1 to identify the updated data pipeline.

In this step, if the sensing entity UE1 moves and is handed over to another RAN node (or because the sensing entity UE1 moves out of an execution area/range of the sensing service 1), UE1 may report such a case to the SSCF through the RAN1 node. For example, the RAN1 node reports indication information, to indicate UE1 to move out of the RAN1 node; or the RAN1 node reports a measurement report of UE1, to notify the SSCF that UE1 is handed over. The foregoing manner of notifying the SSCF to reselect other UE managed by the RAN1 node is used as an example. A specific manner of enabling the SSCF to know that UE1 changes a location and the sensing entity needs to be updated is not limited. The SSCF may be notified based on an existing handover procedure.
(2) The PDF in the SSCF updates a transmission parameter of the updated data pipeline (an example of the quality of service information of the updated data pipeline in the solution in FIG. 7).

For example, a source node of the updated data pipeline is UE3, an intermediate node is the RAN1 node, and a destination node is an SDPF. A QoSS value of the updated data pipeline (with DPID4 or DPID1) is set to 103, a bandwidth is 4 M, and a synchronization delay difference of arriving at the SDPF does not exceed 10 ms.
(3) The PDF in the SSCF updates a collection policy of the updated data pipeline.

For example, content of endpoint collection of UE3 is set, UE3 is set to collect an I/Q signal in real time, and a collection interval of UE3 is set to 100 ns.
(4) The SSCF may indicate to release UE1. A specific notification procedure is not limited, and may be implemented based on an existing procedure.

If a new identifier DPID4 is used to identify a new data pipeline, a node that has stored or received DPID1 may delete the identifier.

It should be noted that different implementations of this application or a part of steps (for example, any one or more steps) in the different implementations may be combined with each other to form a new implementation. In addition, any one or more steps in different implementations do not necessarily include an optional step in an embodiment, or may include a mandatory step in an implementation, or may include an optional step and a mandatory step in an implementation. This is not limited in this application.

It should be noted that, unless otherwise specified or there is a logic conflict, terms and/or descriptions in different implementations are consistent and may be mutually referenced.

It should be noted that a sequence of the steps in implementations of this application is not limited in this application.

It should be noted that a determining sequence of different conditions in implementations of this application is not limited in this application.

It should be noted that “after” and “when” in this application do not strictly limit a time point.

It should be noted that nouns, terms, and the like in this application are merely examples, and other names may be used. This is not limited in this application.

In the foregoing embodiments provided in this application, the method provided in embodiments of this application is described from a perspective of interaction between the devices. To implement functions in the foregoing method provided in embodiments of this application, the first function network element, the second function network element, or the first source node may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

In embodiments of this application, division into modules is an example, and is merely a logical function division. In an actual implementation, another division manner may be used. In addition, functional modules in embodiments of this application may be integrated into one processor, or each of the modules may exist alone physically, or two or more modules may be integrated into one module. The integrated module may be implemented in a form of hardware, or may be implemented in a form of a software functional module.

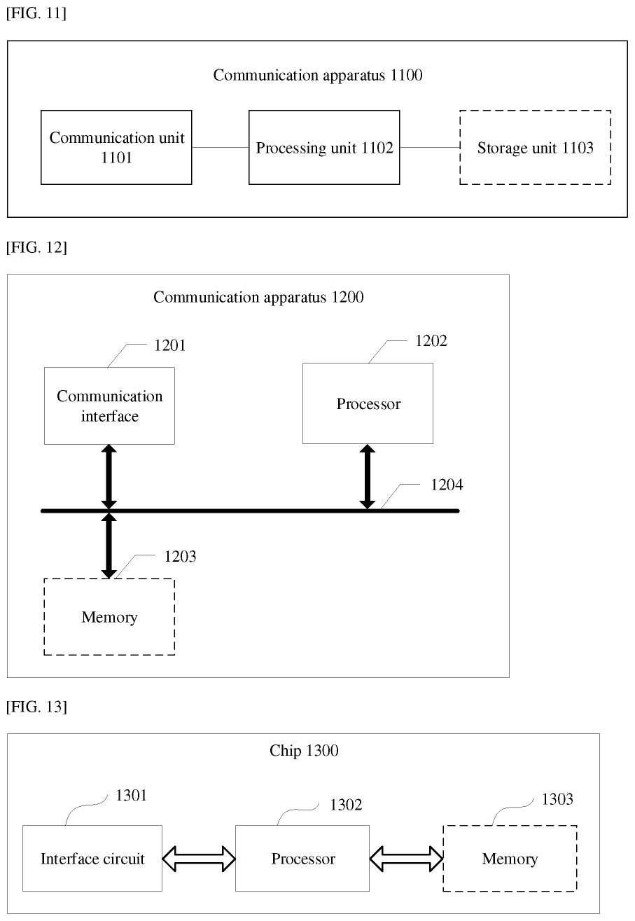

Same as the foregoing concept, as shown in FIG. 11, an embodiment of this application further provides a communication apparatus 1100, configured to implement a function of the first function network element, the second function network element, or the first source node in the foregoing method. For example, the communication apparatus 1100 may be a software module or a chip system. In this embodiment of this application, the chip system may include a chip, or may include a chip and another discrete component. The communication apparatus 1100 may include a communication unit 1101 and a processing unit 1102.

In this embodiment of this application, the communication unit 1101 may also be referred to as a transceiver unit, and may include a sending unit and/or a receiving unit, which are respectively configured to perform the sending and receiving steps of the first function network element, the second function network element, or the first source node in the foregoing method embodiments. The processing unit 1102 may be configured to read instructions and/or data in a storage module, to enable the communication apparatus 1100 to implement the foregoing method embodiments.

In an embodiment, the communication apparatus 1100 may further include a storage unit 1103. The storage unit 1103 is equivalent to the storage module, and may be configured to store the instructions and/or the data.

The following describes the communication apparatus provided in embodiments of this application in detail with reference to FIG. 11 and FIG. 12. It should be understood that descriptions of apparatus embodiments correspond to the descriptions of the method embodiments. Therefore, for content that is not described in detail, refer to the foregoing method embodiments in FIG. 7 and FIG. 8A-1 to FIG. 8A-3. For brevity, details are not described herein again.

The communication unit 1101 may also be referred to as a transceiver, a transceiver machine, a transceiver apparatus, or the like. The processing unit may also be referred to as a processor, a processing board, a processing module, a processing apparatus, or the like. In an embodiment, a component that is in the communication unit 1101 and that is configured to implement the receiving function may be considered as a receiving unit, and a component that is in the communication unit 1101 and that is configured to implement the sending function may be considered as a sending unit. That is, the communication unit 1101 includes the receiving unit and the sending unit. The communication unit sometimes may also be referred to as a transceiver machine, a transceiver, a transceiver circuit, or the like. The receiving unit sometimes may also be referred to as a receiver machine, a receiver, a receive circuit, or the like. The sending unit sometimes may also be referred to as a transmitter machine, a transmitter, a transmit circuit, or the like.

When the communication apparatus 1100 serves as the first function network element in the procedure shown in FIG. 7 in the foregoing embodiments, the communication unit 1101 is configured to obtain identification information of a sensing service; the processing unit 1102 is configured to determine policy information of the sensing service based on the identification information of the sensing service, where the policy information of the sensing service includes first quality of service information of the sensing service; and the communication unit 1101 is further configured to send the policy information of the sensing service to a second function network element.

When the communication apparatus 1100 serves as the second function network element in the procedure shown in FIG. 7 in the foregoing embodiments, the communication unit 1101 is configured to receive policy information of a sensing service from a first function network element, where the policy information of the sensing service includes first quality of service information of the sensing service; and the processing unit 1102 is configured to: determine, based on the policy information of the sensing service, information about at least one data pipeline corresponding to the sensing service, and determine second quality of service information corresponding to each of the at least one data pipeline.

When the communication apparatus 1100 serves as the first source node in the procedure shown in FIG. 7 in the foregoing embodiments, the processing unit 1102 is configured to obtain data of a sensing service based on collection policy information of the first source node by using the communication unit 1101; and the communication unit 1101 is configured to send the data of the sensing service and indication information of second quality of service information of a first data pipeline.

The foregoing is merely an example. The processing unit 1102 and the communication unit 1101 may further perform other functions. For more detailed descriptions, refer to related descriptions in the method embodiments shown in FIG. 7 and FIG. 8A-1 to FIG. 8A-3. Details are not described herein again.

FIG. 12 shows a communication apparatus 1200 according to an embodiment of this application. The communication apparatus shown in FIG. 12 may be an implementation of a hardware circuit of the communication apparatus shown in FIG. 11. The communication apparatus 1200 may be used in the foregoing flowchart, and perform a function of the first function network element, the second function network element, or the first source node in the foregoing method embodiments. For ease of description, FIG. 12 shows only main components of the communication apparatus.

As shown in FIG. 12, the communication apparatus 1200 includes a communication interface 1201 and a processor 1202. The communication interface 1201 and the processor 1202 are coupled to each other. It may be understood that the communication interface 1201 may be a transceiver or an input/output interface, or may be an interface circuit like a transceiver circuit. In an embodiment, the communication apparatus 1200 may further include a memory 1203, configured to: store instructions executed by the processor 1202, or store input data required by the processor 1202 to run the instructions, or store data generated after the processor 1202 runs the instructions.

When the communication apparatus 1200 is configured to implement the methods shown in FIG. 7 and FIG. 8A-1 to FIG. 8A-3, the communication interface 1201 is configured to implement a function of the communication unit 1101, and the processor 1202 is configured to implement a function of the processing unit 1102.

A specific connection medium between the communication interface 1201, the processor 1202, and the memory 1203 is not limited in this embodiment of this application. In this embodiment of this application, in FIG. 12, the memory 1203, the processor 1202, and the communication interface 1201 are connected through a communication bus 1204. The communication bus 1204 is represented by a thick line in FIG. 12. A connection manner between other components is merely an example for description, and is not limited thereto. The communication bus 1204 may be classified into an address bus, a data bus, a control bus, and the like. For ease of representation, only one thick line is used to represent the bus in FIG. 12, but this does not mean that there is only one bus or only one type of bus.

When the communication apparatus is a chip, FIG. 13 is a diagram of a simplified apparatus structure of a chip. The chip 1300 includes an interface circuit 1301 and one or more processors 1302. In an embodiment, the chip 1300 may further include a bus.

The processor 1302 may be an integrated circuit chip and has a signal processing capability. In an implementation process, steps in the foregoing sensing service policy determining method may be completed by using a hardware integrated logic circuit in the processor 1302, or by using instructions in a form of software. The processor 1302 may be a general-purpose processor, a digital signal processor (DSP), an application-specific integrated circuit (application-specific integrated circuit, ASIC), a field programmable gate array (FPGA) or another programmable logic device, a discrete gate or a transistor logic device, or a discrete hardware component. The processor 1302 may implement or perform the methods and steps that are disclosed in embodiments of this application. The general-purpose processor may be a microprocessor, or the processor may be any conventional processor or the like.

The interface circuit 1301 may be configured to send or receive data, instructions, or information. The processor 1302 may process the data, the instructions, or other information received through the interface circuit 1301, and send, through the interface circuit 1301, information obtained through processing.

In an embodiment, the chip further includes a memory 1303. The memory 1303 may include a read-only memory and a random access memory, and provide operation instructions and data for the processor. A part of the memory 1303 may further include a nonvolatile random access memory (NVRAM). In some embodiments, the memory 1303 includes a nonvolatile memory.

In an embodiment, the memory stores an executable software module or a data structure, and the processor may perform a corresponding operation by invoking the operation instructions stored in the memory (the operation instructions may be stored in an operating system).

In an embodiment, the chip may be used in the first function network element, the second function network element, or the first source node in embodiments of this application. Optionally, the interface circuit 1301 may be configured to output an execution result of the processor 1302. For the service node information determining method provided in one or more embodiments of this application, refer to the foregoing embodiments. Details are not described herein again.

It should be noted that functions respectively corresponding to the interface circuit 1301 and the processor 1302 may be implemented by using a hardware design, or may be implemented by using a software design, or may be implemented by using a combination of software and hardware. This is not limited herein.

An embodiment of this application further provides a computer-readable storage medium. The computer-readable storage medium stores a computer program or instructions used to implement the method performed by the first function network element, the second function network element, or the first source node in the foregoing method embodiments.

For example, when the computer program or instructions are executed by a computer, the computer is enabled to implement the method performed by the first function network element, the second function network element, or the first source node in the foregoing method embodiments.

An embodiment of this application further provides a computer program product including a computer program or instructions. When the computer program or instructions are executed by a computer, the computer is enabled to implement the method performed by the first function network element, the second function network element, or the first source node in the foregoing method embodiments.

An embodiment of this application further provides a chip, including a processor, configured to invoke a computer program or computer instructions stored in a memory, so that the processor performs the sensing service policy determining method in the embodiments shown in FIG. 7 and FIG. 8A-1 to FIG. 8A-3.

In a possible implementation, an input into the chip corresponds to the receiving operation in the embodiments shown in FIG. 7 and FIG. 8A-1 to FIG. 8A-3, and an output of the chip corresponds to the sending operation in the embodiments shown in FIG. 7 and FIG. 8A-1 to FIG. 8A-3.

In an embodiment, the processor is coupled to the memory through an interface.

In an embodiment, the chip further includes the memory. The memory stores the computer program or the computer instructions.

The processor mentioned in any one of the foregoing descriptions may be a general-purpose central processing unit, a microprocessor, an application-specific integrated circuit (application-specific integrated circuit, ASIC), or one or more integrated circuits configured to control execution of a program of the sensing service policy determining method in the embodiments shown in FIG. 7 and FIG. 8A-1 to FIG. 8A-3. The memory mentioned in any one of the foregoing descriptions may be a read-only memory (ROM), another type of static storage device that can store static information and instructions, a random access memory (RAM), or the like.

It should be noted that for ease and brevity of description, for explanations and beneficial effects of related content of any one of the communication apparatuses provided above, refer to the embodiment of the corresponding sensing service policy determining method provided above. Details are not described herein again.

In this application, the communication apparatus may further include a hardware layer, an operating system layer running above the hardware layer, and an application layer running above the operating system layer. The hardware layer may include hardware such as a central processing unit (CPU), a memory management unit (MMU), and a memory (also referred to as a main memory). An operating system at the operating system layer may be any one or more computer operating systems that implement service processing by using a process (process), for example, a Linux operating system, a Unix operating system, an Android operating system, an iOS operating system, or a Windows operating system. The application layer may include applications such as a browser, an address book, word processing software, and instant messaging software.

Division into the modules in embodiments of this application is an example, is merely division into logical functions, and may be other division during actual implementation. In addition, functional modules in embodiments of this application may be integrated into one processor, or each of the modules may exist alone physically, or two or more modules may be integrated into one module. The integrated module may be implemented in a form of hardware, or may be implemented in a form of a software functional module.

Through descriptions of the foregoing implementations, a person skilled in the art may clearly understand that embodiments of this application may be implemented by hardware, firmware or a combination thereof. When embodiments of this application are implemented by software, the foregoing functions may be stored in a computer-readable medium or transmitted as one or more instructions or code in the computer-readable medium. The computer-readable medium includes a computer storage medium and a communication medium. The communication medium includes any medium that enables a computer program to be transmitted from one place to another place. The storage medium may be any available medium accessible to a computer. Examples of the computer-readable medium include but are not limited to: a RAM, a ROM, an electrically erasable programmable read only memory (EEPROM), a compact disc read-only memory (compact disc read-only memory, CD-ROM) or another optical disc storage, a disk storage medium or another disk storage device, or any other medium that can be used to carry or store expected program code in an instruction or data structure form and can be accessed by a computer. In addition, any connection may be properly defined as a computer-readable medium. For example, if software is transmitted from a website, a server, or another remote source by using a coaxial cable, an optical fiber and optical cable, a twisted pair, a digital subscriber line (DSL), or wireless technologies such as infrared, radio, and microwave, the coaxial cable, the optical fiber and optical cable, the twisted pair, the DSL, or the wireless technologies such as infrared, radio, and microwave are included in a definition of a medium to which the coaxial cable, the optical fiber and optical cable, the twisted pair, the DSL, or the wireless technologies such as the infrared ray, the radio, and the microwave belong. For example, a disk (disk) and a disc (disc) used in embodiments of this application include a compact disc (CD), a laser disc, an optical disc, a digital video disc (DVD), a floppy disk and a Blu-ray disc. The disk generally copies data by a magnetic means, and the disc copies data optically by a laser means. The foregoing combination should also be included in the protection scope of the computer-readable medium.

In a word, the foregoing descriptions are merely embodiments of this application and are not intended to limit the protection scope of this application. Any modification, equivalent substitution, and improvement made based on the disclosure of this application shall fall within the protection scope of this application.

1. A sensing service policy determining method, wherein the method is applied to a first function network element, and comprises:
obtaining identification information of a sensing service;
determining policy information of the sensing service based on the identification information of the sensing service, wherein the policy information of the sensing service comprises first quality of service information of the sensing service; and
sending the policy information of the sensing service to a second function network element.

2. The method according to claim 1, wherein the policy information of the sensing service further comprises one or more of execution range information of the sensing service or first collection policy information of the sensing service.

3. The method according to claim 2, wherein the first collection policy information comprises one or more of a minimum sensing signal used for sensing measurement, a data collection time interval, or real-time or non-real-time data collection.

4. The method according to claim 1, wherein the identification information of the sensing service corresponds to user information of the sensing service, and wherein the user information of the sensing service comprises one or more of user subscription information of the sensing service, service subscription information of the sensing service, user registration information of the sensing service, or service delay information of the sensing service.

5. The method according to claim 4, wherein the method further comprises:
obtaining the user information of the sensing service from a user management network element of the sensing service.

6. The method according to claim 1, wherein the first quality of service information of the sensing service comprises one or more of a transmission delay of the sensing service, a maximum bandwidth of the sensing service, a guarantee bandwidth of the sensing service, an execution periodicity of the sensing service, a maximum data burst volume of the sensing service, a quantity of nodes participating in the sensing service, a time difference range of synchronous arrival of the data of the sensing service, a deterministic delay of synchronous arrival of the data of the sensing service, or a priority of the sensing service.

7. The method according to claim 1, wherein the policy information of the sensing service further comprises one or more forwarding policy information of the sensing service or security policy information of the sensing service.

8. The method according to claim 1, wherein the second function network element is deployed standalone in one of a core network, an access network, or a network management system, or the second function network element is co-located with a first service network element; and
wherein the first service network element is any one of a data controller, a sensing service control function, a task anchor, or a task scheduler.

9. A sensing service policy determining method, wherein the method is applied to a second function network element and comprises:
receiving policy information of a sensing service from a first function network element, wherein the policy information of the sensing service comprises first quality of service information of the sensing service; and
determining, based on the policy information of the sensing service, information about at least one data pipeline corresponding to the sensing service, and determining second quality of service information corresponding to each data pipeline of the at least one data pipeline.

10. The method according to claim 9, wherein the policy information of the sensing service further comprises collection policy information of the sensing service and
wherein the method further comprises:
determining, based on the collection policy information of the sensing service, collection policy information of a source node corresponding to each data pipeline of the at least one data pipeline.

11. The method according to claim 10, wherein the policy information of the sensing service further comprises execution range information of the sensing service;
wherein the method further comprises:
obtaining one or more of status information of a network or status information of a node within an execution range of the sensing service based on the execution range information of the sensing service; and
wherein the determining, based on the policy information of the sensing service, the information about the at least one data pipeline corresponding to the sensing service comprises:
determining, based on one or more of the policy information of the sensing service, and further based on at least one of the status information of the network, capability information of the node, or the status information of the node, information about a destination node and the information about the source node that correspond to each of the at least one data pipeline.

12. The method according to claim 11, wherein the node is a policy enforcement function network element;
wherein the policy enforcement function network element is deployed standalone and serves a second service network element, or the policy enforcement function network element is deployed in a second service network element; and
wherein the second service network element is any one of a terminal, a radio access network node, an access and mobility management function, a session management function, a unified data repository, a user plane function, or a sensing data processing function.

13. The method according to claim 11, wherein the method further comprises:
sending, based on the information about the source node corresponding to each of the at least one data pipeline, the corresponding second quality of service information and the corresponding collection policy information of the source node to the source node corresponding to the at least one data pipeline.

14. The method according to claim 11, wherein the information about the data pipeline further comprises one or more of information about at least one intermediate node located within the execution range, or identification information of the data pipeline.

15. The method according to claim 11, wherein the method further comprises:
determining, in response to a first source node of a first data pipeline moving out of the execution range of the sensing service, a second node in the execution range of the sensing service, and obtaining an updated first data pipeline by using the second node as a source node of the first data pipeline, wherein the first data pipeline is any one data pipeline of the at least one data pipeline.

16. The method according to claim 15, wherein the method further comprises:
determining second quality of service information corresponding to the updated first data pipeline and collection policy information of the second node; and
sending the second quality of service information corresponding to the updated first data pipeline and the collection policy information of the second node to the second node.

17. A sensing service policy determining method, wherein the method is applied to a first source node of a first data pipeline, and wherein the method comprises:
obtaining data of a sensing service based on collection policy information of the first source node; and
sending the data of the sensing service and indication information of second quality of service information of the first data pipeline.

18. The method according to claim 17, wherein the data of the sensing service and the indication information of the second quality of service information of the first data pipeline are located in a same data packet.

19. The method according to claim 17, wherein the method further comprises:
receiving the second quality of service information of the first data pipeline and the collection policy information of the first source node from a second function network element.

20. The method according to claim 17, wherein the first source node is deployed in a first radio access network node; and
wherein the sending the data of the sensing service and the indication information of the second quality of service information of the first data pipeline comprises:
mapping the first data pipeline to a corresponding first communication tunnel; and
sending the data of the sensing service and the indication information of the second quality of service information of the first data pipeline to at least one of a second radio access network node or a core network element through the first communication tunnel, wherein the second radio access network node and the core network element are destination nodes or intermediate nodes corresponding to the first data pipeline.

21. The method according to claim 17, wherein the first source node is deployed in a terminal device; and
wherein the sending the data of the sensing service and the indication information of the second quality of service information of the first data pipeline comprises:
mapping the first data pipeline to a corresponding first data radio bearer; and
sending the data of the sensing service and the indication information of the second quality of service information of the first data pipeline to a radio access network node through the first data radio bearer, wherein the radio access network node is a destination node or an intermediate node corresponding to the first data pipeline.

22. The method according to claim 20, wherein the first communication tunnel further corresponds to a second data pipeline, and wherein the second data pipeline is configured to transmit data of another sensing service.

23. The method according to claim 21, wherein the first data radio bearer further corresponds to a second data pipeline, and wherein the second data pipeline is configured to transmit data of another sensing service.
